(19) United States
(12) Patent Application Publication
(10) Pub. No.: US 2017/0351838 A1
(43) Pub. Date: Dec. 7, 2017

(54) REMINDER SYSTEM AND METHODS FOR MEDICATION COMPLIANCE

(71) Applicant: Changhai Chen, Bloomfield Hills, MI (US)

(72) Inventors: Changhai Chen, Bloomfield Hills, MI (US); Daniel Chen, Bloomfield Hills, MI (US); Michael Chen, Bloomfield Hills, MI (US)

(21) Appl. No.: 15/613,675

(22) Filed: Jun. 5, 2017

Related U.S. Application Data
(60) Provisional application No. 62/392,621, filed on Jun. 6, 2016.

(51) Int. Cl. G06F 19/00; G06Q 10/10

(52) U.S. Cl. CPC G06F 19/3456; G06F 19/3418; G06Q 10/109

(57) ABSTRACT

A reminder system and methods may be configured for medicine regimen compliance and monitoring. Embodiments may include a control device, a medicine container, a medicine identifier, a medicine container input device, a monitoring device and a portable electrical device. The control device, the medicine container input device and the monitoring device may include microprocessors, memories, input devices and output devices. The control device may provide operations including input and compare, by the microprocessor, a prescription and medicine information. The monitoring device may provide operations including compare, by the microprocessor, the medicine identifier of the medicine container and the medicine information. The monitoring device may also provide operations including determining, by the microprocessor, the amount of medication removed from the medicine container. The operations may further include generate, by the output device, an alert in response to the distance exceeding a threshold.

### CROSS-REFERENCE TO RELATED APPLICATIONS

This non-provisional application is based on and claims priority to U.S. Provisional Patent Application No. 62,392,621 filed Jun. 6, 2016, which is hereby incorporated by reference in its entirety.

### BACKGROUND

Improving medical adherence and compliance is an area of interest for medical practitioners and patients alike. The efficacy of treatment depends on a patient taking medication according to the particular prescription as defined by the medical practitioner. Typical solutions, however, fail to address the root causes of medical non-adherence completely and effectively.

Traditional attempts to improve patient compliance have been physical systems with timer-like functions, or in the form of smart phone applications, to remind patients when to take specific medications. However, these solutions assume that the prescription was accurately filled correctly by a pharmacist and then fail to effectively monitor whether the right dosage has been taken. These solutions merely track how many times the bottle has been opened, but not how many pills are taken at those times. Typical systems have no means of validating that a mechanical reminder device is initially set-up to remind and actually track a particular medication. For example, the particular medication could be replaced by another medication having a different dosage, e.g., if the tracking device is placed on the wrong bottle. Traditional devices are unable to recognize that the medication has been replaced, e.g., resulting in the potential for taking wrong medication. For people taking multiple medications, traditional solutions do nothing to prevent the possibility of a mix-up between medications.

Furthermore, other solutions require pharmacies or clinicians to preprogram the patient's drug routine (e.g., smart bottles) into the solution (e.g., in the form of programming a radiofrequency identification (RFID) tag). Thus, this is a time consuming and expensive process, making it inconvenient and infeasible for patients. Accordingly, this limits accessibility of these solutions to a portion of the population and prevents usage for many patients and caregivers.

Typical pre-sorting pill devices (e.g., pill boxes) may help manage complex medicine regimens, although they also have considerable shortcomings. These devices require the user to actively prepare the medications to be taken over a predetermined period of time (e.g., the next week or month of medication). However, these solutions require significant cognitive effort while pre-sorting the medications. This is both cumbersome for the user, and prone to errors in sorting the medications correctly. For example, it is unlikely the user correctly sorts out the correct medication, in the right dosage, and for the right time all the time. Many of these solutions also fail to effectively remind or notify the patient when to take a certain dosage of medication.

Accordingly, there is a need for a system that can not only remind patients when to take specific medications, but also track that the correct dosages have been taken by the patient at the correct time and ensure that the right medication is taken. A further need exists for a system that notifies patients to bring their medications along when they leave their homes. Moreover, there is a need for a system that ensures compliance, while still remaining accessible to the average patient (e.g., requiring no or minimal changes to the patient's lifestyle). These systems may operate without relying on pharmacists or clinicians to program the device, increasing the accessibility to larger populations.

### BRIEF DESCRIPTION OF THE DRAWINGS

The advantages of the present disclosure will become readily apparent from the following detailed description when considered in light of the accompanying drawings, in which:

FIG. 1 illustrates an exemplary system of the present disclosure including, for example, exemplary embodiments of a control device, an alert device such as a travel alert unit (“TAU”), a medication input device (e.g., a prescription input device) such as a medication container information input unit (“MCIIU”), an identification device such as one or more medication container identification units (“MCIDU”), and a reminder device such as one or more medication storage and reminder units (“MSRU”) for one or more medications;

FIG. 2 illustrates a perspective view of an exemplary embodiment including, for example, a medication input device (e.g., MCIIU) of FIG. 1;

FIG. 3 illustrates a perspective view of an exemplary embodiment including, for example, an identification device (e.g., MCIDU) of FIG. 2;

FIG. 4 illustrates a perspective view of an exemplary system including, for example, a reminder device (e.g., MSRU), an original (e.g., standard) medication container, and/or an identification device (e.g., MCIDU) of FIG. 1;

FIG. 5 illustrates an exploded view of an exemplary embodiment including, for example, an identification device (e.g., the MCIDU) of FIG. 4 with a radiofrequency (RF) tag or a barcode (e.g., one, two, or three dimensional);

FIG. 6 illustrates a perspective view of an exemplary embodiment including, for example, an identification device (e.g., MCIDU) and/or a reminder device (e.g., MSRU);

FIG. 7 illustrates a side view of an exemplary embodiment of FIG. 6;

FIG. 8 illustrates a cross-section view of the exemplary embodiment of FIG. 6;

FIG. 9 illustrates a perspective cut-out view of the exemplary embodiment of FIG. 6;

FIG. 10 illustrates a perspective view of an exemplary embodiment including, for example, a reminder device (e.g., MSRU) and/or an identification device (e.g., MCIDU) having an alphanumeric (e.g., letters and/or numbers) identifier;

FIG. 11 illustrates an exploded view of the exemplary system of FIG. 10;

FIG. 12 illustrates a perspective view of another exemplary embodiment including, for example, a reminder device (e.g., MSRU) and/or an identification device (e.g., MCIDU) having an adapter configured to receive a container (e.g., a cylindrical container of liquid medication) of FIG. 1;

FIG. 13 illustrates a perspective view of another exemplary embodiment including, for example, a reminder device (e.g., MSRU) and/or an identification device (e.g., MCIDU) having an adapter configured to receive or attach to one or more uniquely or custom shaped containers (e.g., having any size, dimensions, or shape such as a rectangular container) of FIG. 1;

FIG. 14 illustrates a perspective view of an exemplary embodiment including, for example, a smart medicine cabinet and/or cart;

FIG. 15 illustrates a perspective view of an exemplary embodiment including, for example, an alert device (e.g., TAU) of FIG. 1;

FIG. 16 illustrates a schematic diagram including, for example, an embodiment of a hardware structure of a control device;

FIG. 17 illustrates a schematic diagram for an exemplary system including, for example, a network structure in which reminder and tracking devices relay medication information (e.g., adherence information) to other devices and for access by one or more users;

FIG. 18 illustrates a flow diagram including an exemplary process including, for example, methods of using the embodiments of the present disclosure;

FIG. 19 illustrates a flow diagram including an exemplary process including, for example, methods of using the embodiments of the present disclosure to input medication (e.g., prescription) regimen data;

FIG. 20 illustrates a schematic diagram illustrating the hardware structure of the present disclosure, e.g., with respect to a medication input device (e.g., MCIIU);

FIG. 21 illustrates a flow diagram including an exemplary process including, for example, operations of a medication input device (e.g., MCIIU);

FIG. 22 illustrates a schematic diagram including, for example, a reminder device and an identification device (e.g., MSRU and MCIDU having an integrated hardware structure);

FIG. 23 illustrates a flow diagram including an exemplary process, for example, of a reminder device (e.g., MSRU);

FIG. 24 illustrates a schematic diagram including, for example, an exemplary system having an identification device (e.g., MCIDU) with hardware and communication structures;

FIG. 25 illustrates a flow diagram including an exemplary process, for example, of an identification device (e.g., MCIDU);

FIG. 26 illustrates a flow diagram including an exemplary process including, for example, operations for utilizing identifiers such as passive RFID tags or barcodes for MCIDU (e.g., 1D or 2D);

FIG. 27 illustrates a flow diagram including an exemplary process, for example, exemplary operations for utilizing pictures and optical character recognition/optical character reader (“OCR”) for MCIDU;

FIG. 28 illustrates a schematic diagram including, for example, an exemplary alert device (e.g., TAU);

FIG. 29 illustrates a flow diagram including an exemplary process, for example, of an alert device (e.g., TAU);

The following description is merely exemplary in nature and is not intended to limit the present disclosure, application, or uses. It should be understood that throughout the drawings, corresponding reference numerals indicate corresponding parts and features.

### DETAILED DESCRIPTION

Embodiments may relate to devices for medication compliance. More specifically, a portable monitoring device may be configured to notify users when to take their medications and logging when medications have been taken, automatically through a programmable patient apparatus. Systems and methods are provided for medicine regimen compliance and monitoring. For example, a user may attach an identifier to a medicine container that is received with medicine. The medicine (e.g., prescription) information and medicine container information may be entered or input into the system, which may associate or couple the identifier, the medicine, medicine container together. In another aspect, a medicine container having an identifier is coupled with a monitoring device via the identifier. In another aspect, prescription regimen data is input into the system. The system compares the prescription and medicine information and couples prescription, medicine, identifier, and monitoring device together. The prescription information is transferred to the monitoring device. In another aspect, an amount of medication removed from a container may be determined and compared to a medicine regimen to determine compliance or non-compliance. In another aspect, a distance between a portable electronic device and a medicine container may be electronically monitored. In response to the distance exceeding a predefined threshold, an alert may be signaled.

Exemplary systems may also include and utilize devices configured to assist users in managing either their medications or the medications of another person (e.g., someone they are taking care of). Using medication identification, the systems may notify patients when to take specific medications and track the exact dosage taken by a patient at particular times, while ensuring the notification is for the originally intended medication. By way of prescription data and medicine information input, the system may be programmable by users such as patients or caregivers. Moreover, location tracking may be utilized to remind patients when medications may have been forgotten at home. Any of the operations herein may be implemented as methods of a computing device or as instructions stored on a computer readable medium. All or any portion of the systems herein may be portable, modular, or integrated.

Furthermore, exemplary systems may be configured to receive or input medication (e.g., prescription) information into a control device, to receive or input medication information (e.g., prescription regimen data), to couple or associate the medication information and the medication container, to identify medication containers, to notify users when and how to take their medications according to the prescription regimes, to check whether the right medication and dosage has been taken, and to take the medications when they travel. Further structures and operations will become apparent from the description provided herein.

An exemplary system may comprise a control unit or device, a travel alert unit (“TAU”), a medication container information input unit (“MCIIU”), medication container identification unit (“MCIDU”), and a medication storage and reminder unit (“MSRU”). The system may receive information using radio frequency identification (“RFID”) and optical character recognition/optical character reader (“OCR”). The system may transfer information using near field communication (“NFC”), a local area network (“LAN”), or a wide area network (“WAN”). The system may determine and transfer location information by way of a global positioning system (“GPS”).

A method of medicine regimen compliance and monitoring may comprise determining an amount of medication removed from a container and comparing the amount removed to a medicine regimen to determine compliance or non-compliance. A method of medicine regimen compliance monitoring may also comprise applying an identifier to a medicine container and coupling the medicine container with a monitoring device. The monitoring device may check correspondence between the identifier of the medicine container and the monitoring device, and if a lack of correspondence is found, signal an alert. A method of medicine regimen compliance and monitoring may comprise machine reading a prescription and a label of a medicine container, and comparing the information and transferring the information derived from the machine reading to a monitoring device. A method of medicine regimen compliance and monitoring may comprise electronically monitoring a distance between a portable electronic device and a medicine container and when the distance exceeds a threshold, signaling an alert.

An exemplary system may be configured for medicine regimen compliance and monitoring. The system may comprise a monitoring device configured to receive a medicine container having an identifier to form a coupling between the monitoring device and the medicine container. The monitoring device may comprise a controller with a processor (e.g., microprocessor) and memory with a program for receiving a program for alerting a user when a medicine is to be taken, and circuitry responsive to the controller for producing an alert. The monitoring device may further comprise circuitry for determining an amount of medicine present in the medicine container. The system may further comprise devices reading a label of the medicine container and transferring to the monitoring device information derived from machine reading. The system may further comprise a portable electronic device for monitoring a distance between the portable electronic device and the medicine container. The portable electronic device may be configured to generate an indication (e.g., signal an alert) when the distance exceeds a predefined threshold.

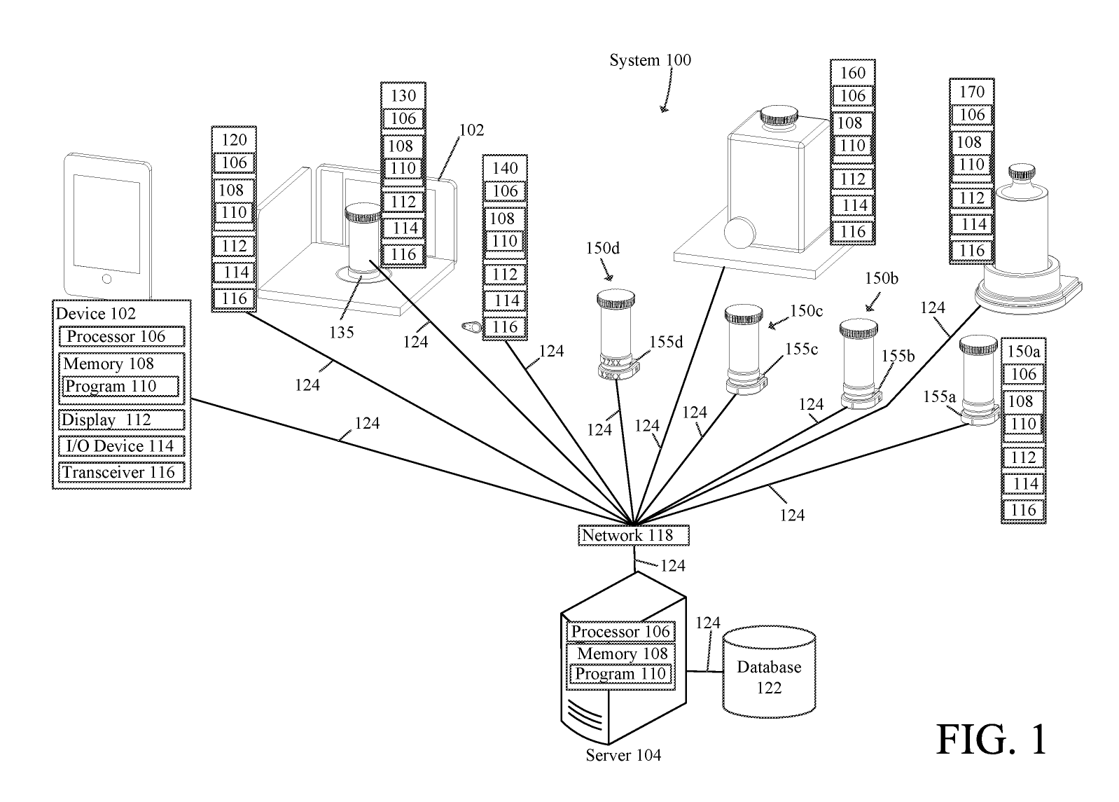

FIG. 1 illustrates an exemplary system 100 that is configured to receive, monitor, and transfer medication information, e.g., for notifying users when to take their medications and monitoring the dosage and usage of prescription medication. The system 100 may include a controller or control device 102, a mediation input device 120 (e.g., MCIIU), an assembly 130 (e.g., MCIDU), an alert device 140 (e.g., TAU), assemblies 150a-d, 160, 170, or a combination thereof, which may be referred to as assemblies 102-170. Assemblies 150a-d, 155, 160, 170 may include one or more input, storage, and/or reminder devices (e.g., MCIDU and/or MSRU). The system 100 may further include server 104, network 118, database 122, and connections 124. Devices/assemblies 102, 120, 130, 140, 150, 160, and/or 170 (hereinafter “assemblies 102-170”) and server 104 may include a processor 106, memory 108, and program 110. Assemblies 102-170 may include display 112, input/output (I/O) device 114, and transceiver 116.

Medication information may include any information associated with medication or medicine. Medication information may be associated with or include a prescription (e.g., patient name, prescriber name, strength, dosage, quantity, expiration, use directions, or drug or diet interactions), a container type (e.g., shape, size, or color), patient information (e.g., name or history), or a combination thereof. Medication information may include other information associated with a patient or medication.

Prescription information may include medication information associated with a patient or as prescribed or defined by a user such as medical professional or a patient. Container information may include medication information associated with a medication container or according to an identifier on a medication container. As such, the prescription information and container information may or may not match depending on whether the prescription was properly and accurately fulfilled or not. The container information may match the medication information if the content of the medicine container complies with the prescription, and thus the system may generate a notification or alert indicating compliance. The container information may not match the medication information if the contents of the medicine container do not comply with the prescription, and thus the system may generate a notification or alert indicating non-compliance. Accordingly, the systems herein may compare the prescription information and the container information to determine medication compliance or non-compliance.

Embodiments may utilize and compare multiple types of information, e.g., related information received from distinct sources. For example, the system may receive information associated with a prescription (e.g., as defined by a user such as medical professional or patient), a medication or medicine (e.g., as defined by the contents of a medication container or by a manufacturer), and a medication container (e.g., as defined by the size and shape of the container or as labeled on the container). These types of information should be the same if everything was entered and received correctly, but because the information is input separately, the information from various sources may not be the same. For example, errors may be introduced by way of manual inputs, user mismatches, computer transfer, RF reader, OCR, etc. As such, the system herein leverages the information from various sources to increase the accuracy of the medication actually taken by the patient. More specifically, the information is received from distinct sources and compared to determine compliance or non-compliance, thereby reducing the likelihood of error with multiple ways of receiving the same types of information. Depending on whether there is a match or mismatch, the system may alert or notify the user regarding the same to reduce the possibility of the patient taking the wrong medication. Accordingly, the system may be advantageous in increasing the effectiveness of treatment, e.g., by information redundancy and monitoring information with respect to at least two sources.

The system 100 may include an overall network infrastructure through which the assemblies 102-170, servers 104, and database 122 may communicate, for example, to transfer medication information between the other of assemblies 102-170, servers 104, and database 122, e.g., using connections 124. In general, a network (e.g., system 100 or network 118) may be a collection of computing devices and other hardware to provide connections and carry communications. As an example, each device may communicate with every other device through the use of a wired or wireless network or a combination thereof, e.g., using any wired or wireless connection including direct wiring, Ethernet wiring, radio frequency (RF), cellular phone service, GPS, Bluetooth, infrared (IR) signals, or any other connection.

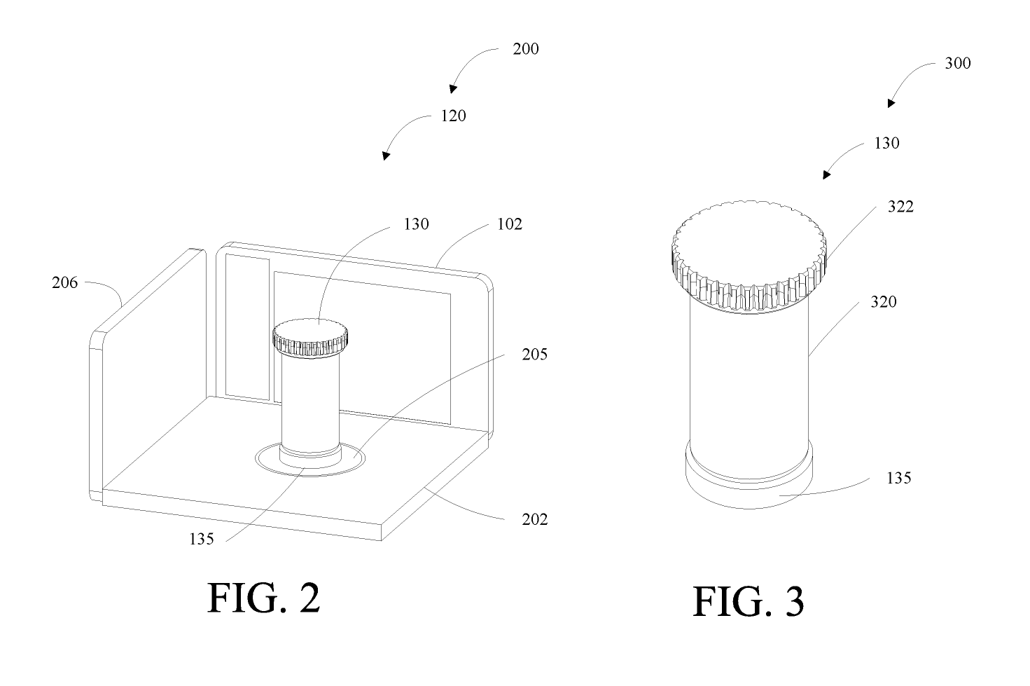

FIG. 2 illustrates exemplary system 200, e.g., configured for medication input device 120. System 200 may include medication input device 120 that can be part of the control device 102 or a separate, standalone device. System 200 may also include identification device 135 (e.g., RFID tag), wall 206, and base 202 with a container holding device 205. The holding device 205 may rotate the medicine container such that the medication input device 120 may take one or more images (e.g., pictures or videos) of the assembly 130, e.g., as needed for OCR. Alternatively or in addition, the control device 102 may have I/O device 114 including, for example, one or more cameras or scanners to take images from different angles to be utilized for OCR to transcribe the prescription into text form.

FIG. 3 illustrates exemplary assembly 300 including, for example, assembly 130 having container 320 (e.g., medicine container), cap 322, and identification device 135. The device 135 may be attached to the container 320 by a patient or a caregiver. Device 135 may have different shapes and sizes.

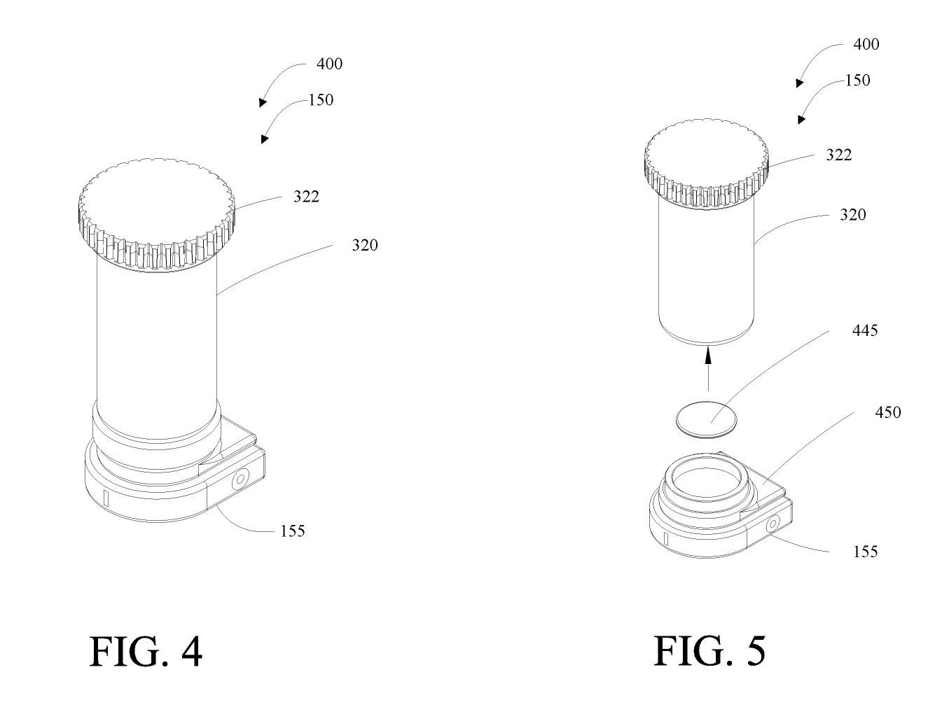

FIG. 4 illustrates an exemplary assembly 400 including, e.g., the assembly 150 in an assembled condition. The assembly 150 may include container 320, cap 322, and reminder device 155 (e.g., MCIDU and/or MSRU). The assembly 150 may include container information such as an identifier associated with medication information, which may be stored on memory 108 or database 122.

FIG. 5 shows an embodiment of assembly 400 including identification device 150 in an exploded or disassembled condition. Assembly 150 may include tag 445 (e.g., RFID tag), adapter 450, container 320 (e.g., medicine container), cap 322, and reminder device 155 (e.g., MCIDU and/or MSRU). The tag 445 may be the identification device 135, as described above. Tag 445 may include a peel off tag, a radiofrequency (RF) tag or a barcode label (e.g., 1D or 2D). Tag 445 may be permanently or releasably attached to container 320 by a patient or a caregiver. Adapter 450 may include a cavity or recess to receive the tag 445 between the adapter 450 and container 320.

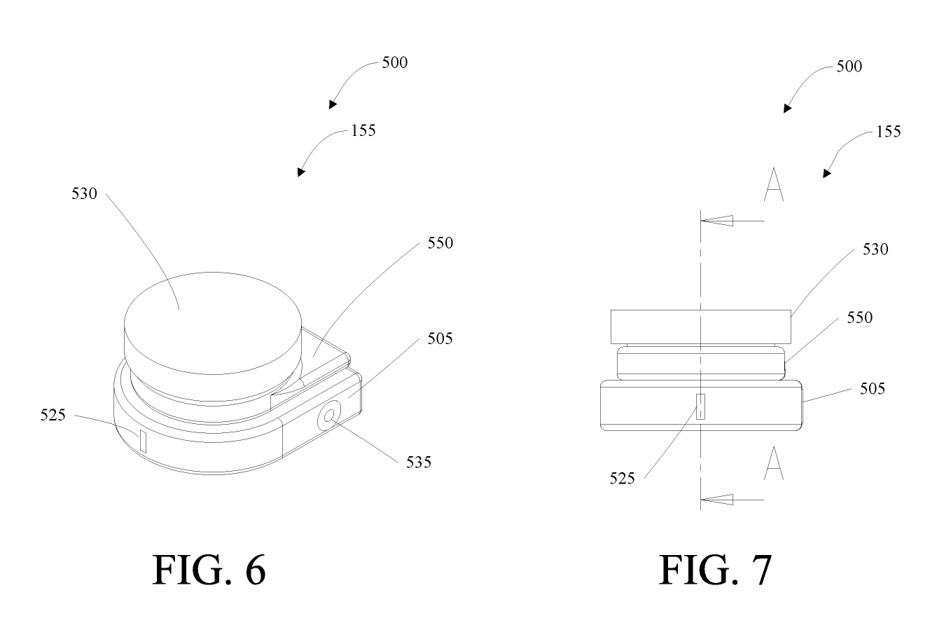

FIGS. 6-7 illustrate system 500 including, for example, reminder device 155 (e.g., MCIDU and/or MSRU). The reminder device 155 may include cap 530, one or more lights 525, speaker 535, and adapter 550. Adapter 550 may include a cavity or recess to receive a medicine and may be configured to releasably engage cap 530. Cap 530 may also be referred to as Unit A.

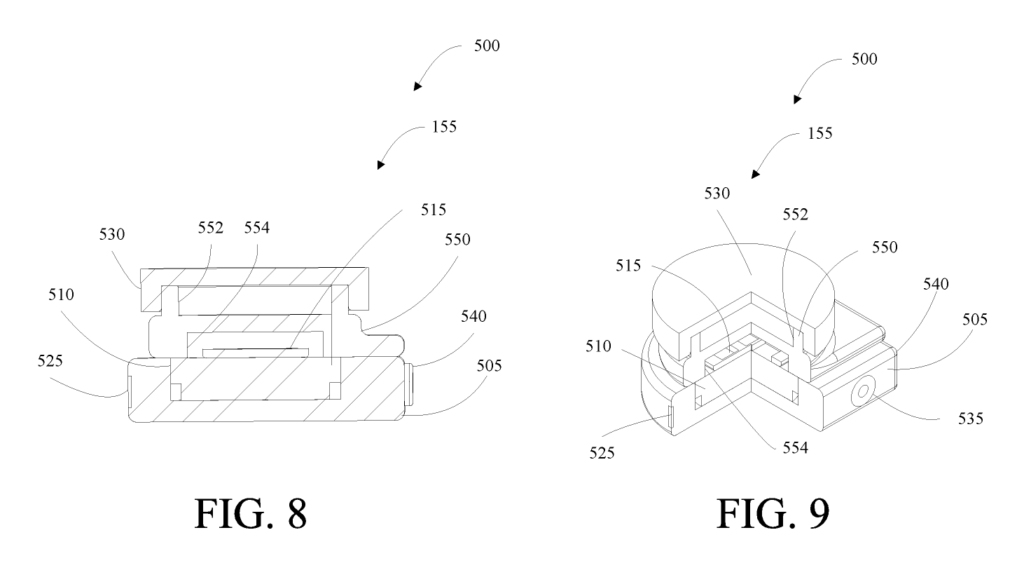

FIGS. 8-9 illustrate a cross-section and cutout views of system 500 including, for example, reminder device 155. Reminder device 155 may include housing 505, scale 510, reader 515 (e.g., RFID reader), one or more lights 525, cap 530, one or more buttons 540, and adapter 550. Adapter 550 may include an upper cavity 552 configured to receive a medicine and a lower cavity 554 configured to receive reader 515. Housing 505 may also be referred to as Unit B.

Cap 530 may be permanently or releaseably attached to container 320 by a user. Device 530 may also be releaseably attached by a user to housing 505 (e.g., of MSRU). Cap 530 may include an identifier (e.g., unique identification information) for that particular device or unit. The identifier may include unique numbers and/or letters, an RF tag, barcodes, or unique shape/identifying marks.

Cap 530 may be configured as a cap or disc. Cap 530 may have a peel off label, RFID tag, or a barcode label (e.g., 1D or 2D). Cap 530 may be disposable, e.g., when all the medication inside the medicine container has been consumed. While cap 530 is attached to a medicine container, the label for cap 530 may be an identifier (e.g., medicine identifier). Each medicine container may have a unique identifier.

Cap 530 may be releasably attached to the remainder of system 500, e.g., adapter 550. Cap 530 may be intentionally adapted to require significant effort to remove. Cap 530 may be multiple components or pieces configured to be attached to a medicine container, e.g., with the last component being used as the identifier for the container. Cap 530 may have an illuminating indicator, such as an illuminated RF tag, label, light, or the like. The indicator may turn on as a notification system, e.g., to indicate to take medicine from this container and/or to communicate with the control device.

The adapter 550 is attached to the reminder device 155 (e.g., of MCIDU/MCIU). The reminder device 155 may include an RF reader, a barcode reader, sensors (including area and location such as touch screen), one or more cameras, or a combination thereof. Housing 505 may include a recess or cavity configured to receive scale 510 or a medication. The adapter 550 may be configured to be releasably attached to the housing 505.

Cap 530 may be configured to be physically attached or linked to the adapter 550. Adapter 550 may be configured to be physically attached or linked to the reminder device 155 (e.g., MCIDU/MSRU). While assembly 130 of the medicine container 320 and cap 530 is attached or linked to housing 505 through the adapter 550, the housing 505 may be configured to read the identifier (e.g., unique ID) for the medicine container. The device 155 may be configured check whether the correct container is in the adapter 550 or not.

The link between the adapter 550 and cap 530 may be either a physical or electrical signal. The adapter 550 and cap 530 may be physically connected together but removable, such as by way of a threaded connection, twist lock, or clamp. Alternatively or in addition, the link between adapter 550 and cap 530 may simply be in proximity to each other—close enough to each other to transmit electrical signals. The device 155 may continuously check whether the identifier is correct. In this embodiment, the assembly 130 and the housing 505 may separate when needed. For example, separation may be advantageous for ease of use, e.g., when traveling. The assembly 130 and housing 505 may be put back together after arriving at a destination.

The link between the adapter 550 and the housing 505 may form a solid but removable connection (i.e. the link may be configured to resist being opened or separated unintentionally), such as a threaded link, a twist lock, or a clamp. Users can use different adapters for different medicine containers (e.g., vials, liquid bottles, big packages, blister packs) while still using the same housing 505.

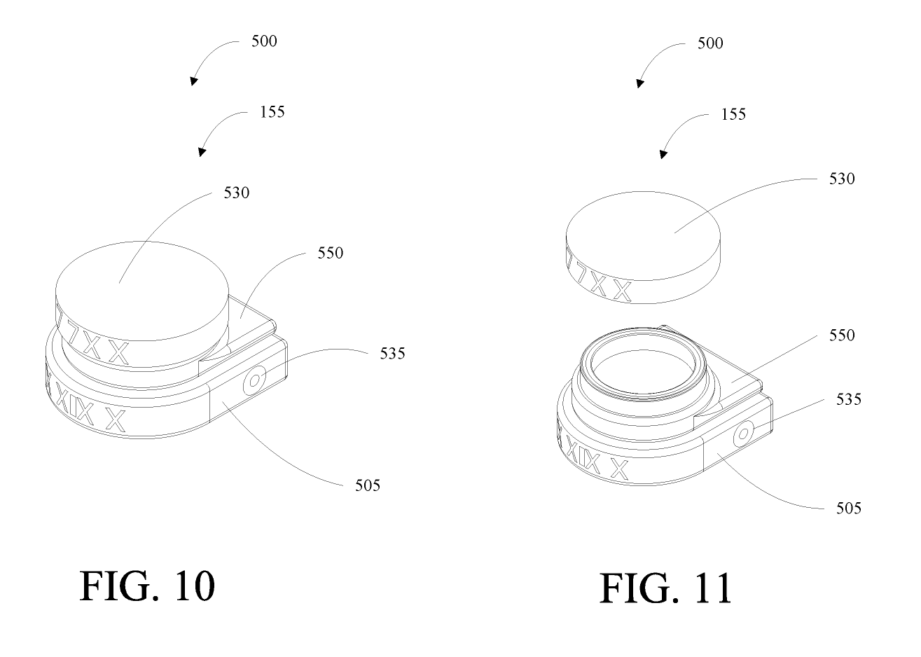

FIGS. 10-11 illustrate system 500 including, for example, another embodiment of device 155. Device 155 may use letters and/or numbers. The cap 530 may be a plastic disc or cap with unique numbers, letters, or a combination thereof. The housing 505 may also have unique numbers or letters or both. These unique numbers or letters may be used as a means of identification, to uniquely label each medicine container.

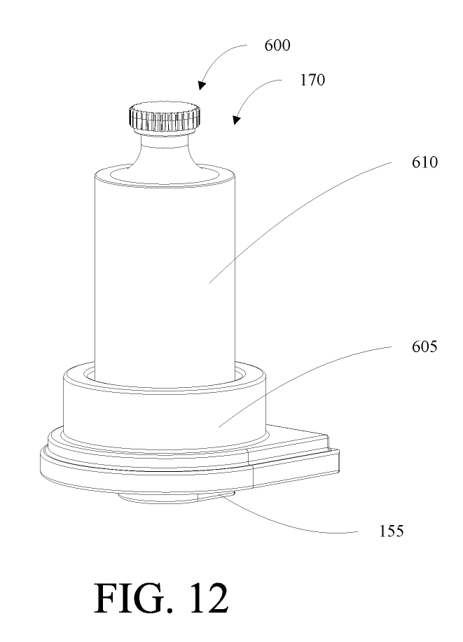

FIG. 12 illustrates exemplary system 600 including, for example, assembly 170. System 600 may include device 155 and an adapter 605. Adapter 605 may include a recess adapted to receive for container 610. Container 610 may include a liquid container of medication. One or more adaptors 605 may include the same or a different geometry and shape. The adaptor 605 may correspond to the shape of container 610. The device 155 may remain the same geometry and/or shape.

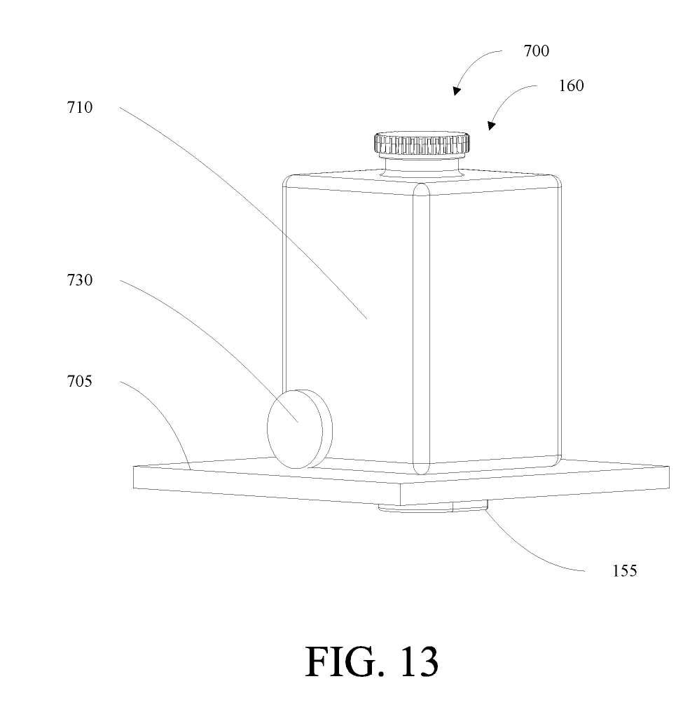

FIG. 13 illustrates an exemplary system 700 including, for example, assembly 160. System 700 may include device 155 with an adapter 705 designed for non-conventional prescription containers of any size and/or shape in this embodiment of the disclosure. The medicine container 710 (e.g., medicine container) sits on the adapter 705. Cover 730 of the device 155 is attached to the container 710.

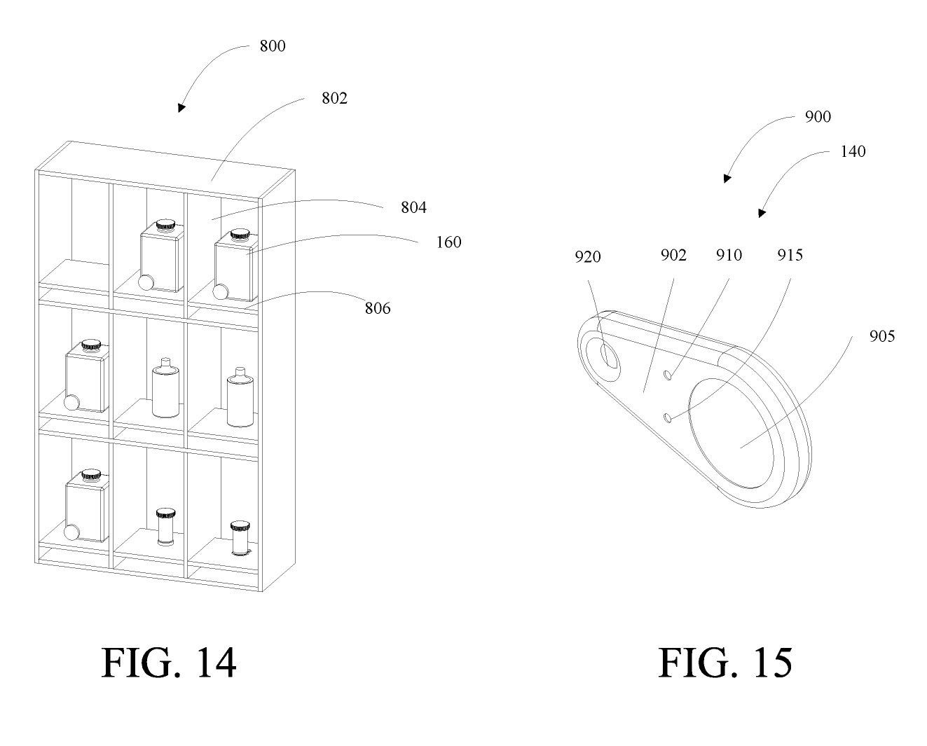

FIG. 14 illustrates system 800 with a smart medicine cabinet 802 with a plurality of compartments 804 configured to receive multiple assemblies 160, e.g., one or more system 700 with adapters 705. These adapters 805 also form shelves 806 of the cabinet. Cabinet 802 may be mounted on a wheeled platform. Cabinet 802 may be mobilized as a smart medicine cart.

FIG. 15 illustrates system 900 including, for example, alert device 140 (e.g., TAU). Alert device 140 may include reset button 905, an illuminating indicator 910, a buzzer 915, and a hole 920, e.g., for easy attachment. Alert device 140 may be a standalone device, such as a key chain, brace let, or wearable device. Alert device 140 may include or be configured as a smart phone app, or a tablet app. Device 140 may include processor 106, memory 108, program 110, display 112, input/output device 114, and communication device (e.g., transceiver 116).

The devices and systems herein may be configured to work with any medicine container that a patient could receive, for example, from a pharmacy, hospital, or other such facility. The medicine container may be of any size, shape, color, form, or weight. The medicine may be of any form: pill, liquid, powder, gas, blister, etc. Any of this information may be part of the medication information.

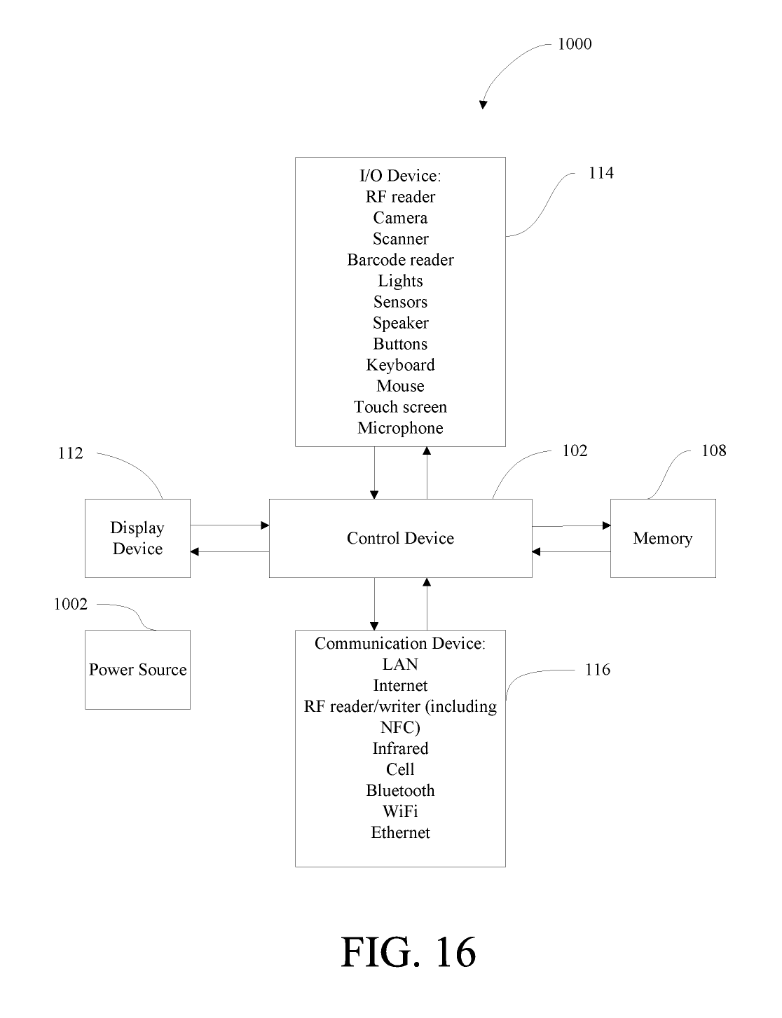

FIG. 16 illustrates a schematic diagram of system 1000. System 1000 may include a hardware structure of the control device 102. System 1000 may include control device 102, memory 108, display device 112, I/O device 114, transceiver 116, and power device or unit 1002. The control device 102 may be any type of general or specific purpose processor, such as a standalone station with a processor inside, a local computer, a tablet, a remote computer server, a cloud server, or a smart phone. The control device 102 also includes a display device which can be a computer monitor, a tablet display, a smart phone display, etc. The power supply or source 1002 may be configured to either AC and or DC power, such as a lithium ion battery system, is contained inside the control device and powers the entire system. If the system uses rechargeable batteries, the power source may monitor the power remaining and give reminder signals to recharge batteries once the batteries are low. The control device 102 may include memory that can store medication information including prescription information, medicine container identification information and patient's medical history information. The control device 102 may include an I/O device 114 such as an RF reader, camera, scanner, barcode reader (e.g., 1d or 2d), one or more lights, one or more sensors, speaker, one or more buttons, keyboard, mouse, touch screen, microphone, or a combination thereof

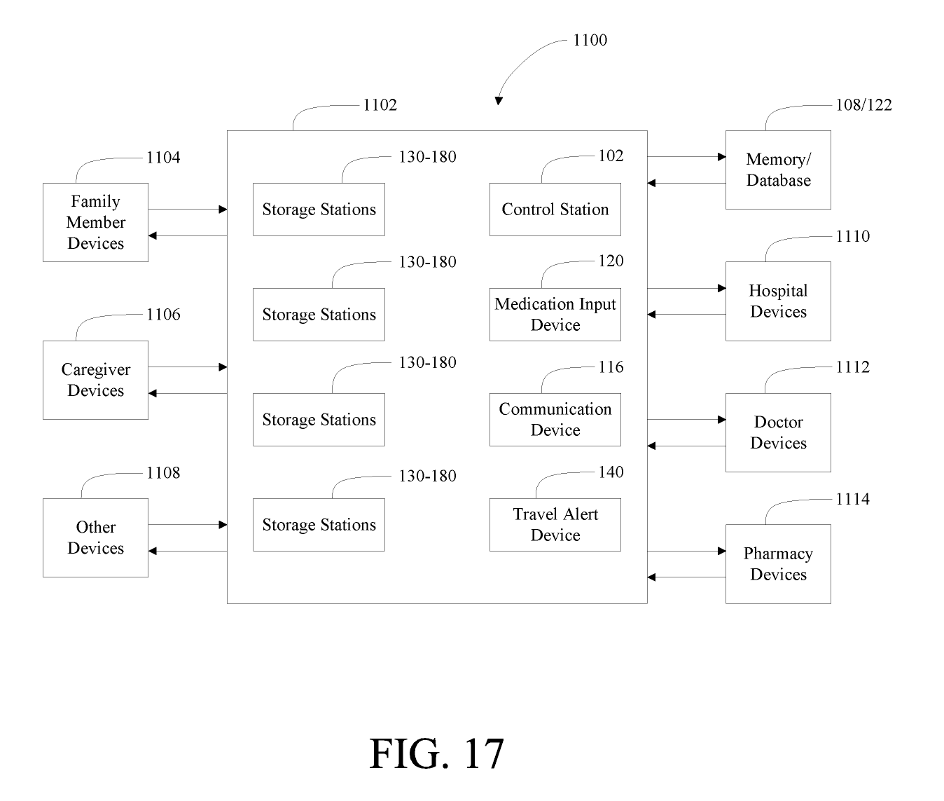

FIG. 17 illustrates a schematic diagram of system 1110. System 1100 may include system 100. System 1100 may include any combination of reminder and tracking systems. System 1100 may be configured to relay medication adherence information to other devices and can then be accessed by various parties. Transceivers 116 (e.g., a communication module) may be configured to communicate with each other and for the system 1100 to communicate with other systems or devices. The system 1100 is able to communicate information to doctors, hospitals, pharmacies, caregivers, family members, remote servers, or cloud storage sites.

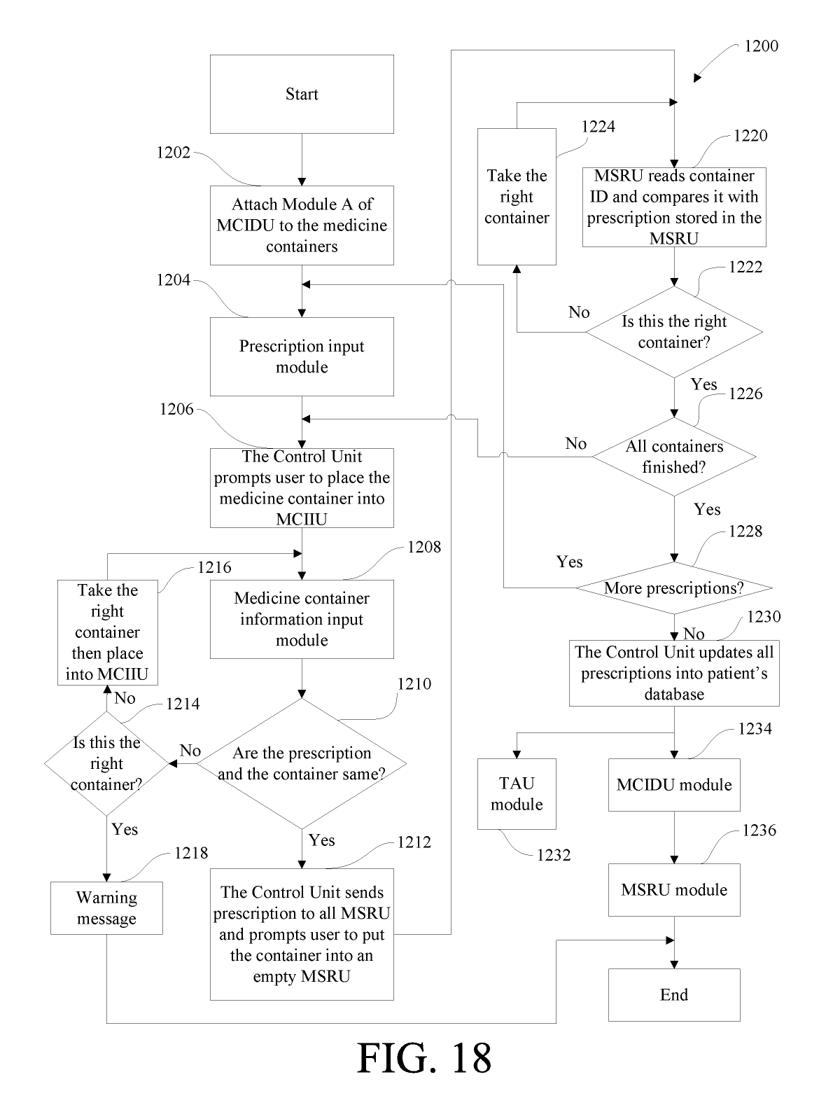

FIG. 18 illustrates a flow diagram of process 1200, e.g., for the systems herein. Process 1200 may include operations that may be part of program 110, stored on memory 108, and/or executed by processor 106. Process 1200 may take many different forms and include multiple and/or alternate steps. While an exemplary process is shown, the exemplary steps illustrated are not intended to be limiting. Indeed, additional or alternative steps and/or implementations may be used.

At block 1202, identification device 135 may be attached to medicine container 320.

At block 1204, processor 106 may initiate a prescription input module.

At block 1206, the control device 102 may initiate a user prompt (e.g., to place the medicine container assembly 130 onto the medication input device 120).

At block 1208, the processor 106 may initiate a medicine container input module.

At block 1210, the processor 106 may determine whether the medicine identifier (e.g., prescription) and the container identifier are the same. If yes, the control device 102 may send the medication information to all reminder devices (e.g. MSRU). If no, the processor 106 may determine if the medicine container assembly 130 is correct.

At block 1212, the control device 102 may send medication information to any or all of the reminder devices 155 and initiate one or more user prompts (e.g., to put the container into an empty reminder device 155).

At block 1214, the processor 106 may determine if the medicine container is correct. If no, the display 112 or I/O device 114 may generate an indication for the correct medicine container assembly 130. If yes, the display 112 or I/O device 114 may generate an indication (e.g., warning message).

At block 1216, the display 112 or I/O device 114 may generate an indication that the correct medicine container assembly 130 should be placed into the medication input device 120.

At block 1218, the display 112 or I/O device 114 may generate an indication (e.g., warning message).

At block 1220, the reminder device 155 may read the container information (e.g., identifier) and compare the container information to the medicine information (e.g., prescription) stored in the database 122 or memory 108, e.g., of the reminder device 155.

At block 1222, the processor 106 may determine whether the medicine container assembly 130 is correct based on the comparison.

At block 1224, the display 112 or I/O device 114 may generate an indication to take the correct medicine container assembly 130.

At block 1226, the processor 106 may determine if all the medicine containers assembly 130 are finished.

At block 1228, the processor 106 may determine if there are more prescriptions.

At block 1230, the processor 106, e.g., of control device 102, may update one or all of the prescriptions of the patient in database 122.

At block 1232, the processor may be in communication with and initiate the alert device 140 (e.g., TAU).

At block 1234, the processor 106 may initiate a medicine container identification module.

At block 1236, the processor 106 may initiate a medicine storage and reminder module. After block 1236, the process ends.

Process 1200 may include alternative or additional embodiments. For example, cap 530 may be placed on medicine container 320 of any type, picked up from the pharmacy or other facility, and then places the combined assembly 130 on the medication input device 120. Then, after inputting the prescription regimen into the control device 102, the control device 102 may check the prescription against the National Drug Database (NDD) and patient's medical records and drug history for any potential conflicts (e.g. potential allergic reactions, wrong dosage, wrong medicine for the condition, dangerous combinations of multiple medicines, etc.). Then the information on the medicine container 320 is input via medication input device 120. This information may include, but is not limited to, the patient's name, the name and strength of the drug, directions for how to use the drug, quantity of the drug, national drug code (NDC) of the drug if available, and ID information for the medicine container assembly 130. The control device 102 then compares the prescription and information obtained from the medicine container to ensure consistency. After the control device 102 checks the information and finds no error, it may link the container ID and the medicine together and sends all information to one or all devices 155 and prompt the user to place the medicine container 130 into an empty medicine storage and reminder unit (MSRU). Assemblies 120-170 as shown in FIG. 1 include container assemblies and reminder devices 155 (e.g., MCIDU/MSRU). The reminder device 155 (e.g., MSRU) may include assembly 130 (e.g., MCIDU) as a single component with reminder device 155. Alternatively, reminder device 155 and assembly 130 may be separate components.

Then, the reminder device 155 reads in the container ID information and checks to verify that a valid medicine container has been placed in the reminder device 155. The reminder device 155 then may notify users when and how to take their medications according to the prescription regimen data by sending visual and auditory alerts It may also send alerts to a remote computer or other devices (e.g. phone application). These notifications may include the amount of medicine to take at each alert as well any special prescription instructions such as reminders to take the medication with food, which medication to take first, etc. These alerts may be sent before the medications are scheduled to be taken and continuing alerts may be sent until the medications are taken (if the medications are not taken.)

After the medications are taken, the reminder device 155 checks whether the right dosage has been taken, sending visual and auditory alarm signals if the wrong dosage has been taken. The reminder device 155 may also send alarm signals to remote devices such as remote computers, tablets, wearable devices, or phones, which can be received by the patient or the patients care team (e.g. doctors, caregivers, and family members).

The system can work with any medicine containers that patients receive from pharmacies, hospitals, or other facilities (i.e. the medicine container can be of any size, shape, color, form, or weight). The medicine itself can take on any form; for example, the medication could be pills, liquids, powders, gaseous, blister, etc.

The system can be remotely set up or monitored. A third party (caregiver, family number, monitor companies, etc.) can remotely log into the system to use the control device 102 and medication input device 120 to check that all information is correct or to set up the whole system, including inputting prescription information, inputting container information, and setting up medication schedules. The system may monitor itself and generate error codes if anything is wrong and then send an alarm signal to a group of predefined third parties to alert them of malfunctions.

All communication occurs through a wired or wireless network, or the combination of both. Possible examples of wired and wireless networks include, direct wiring, Ethernet wiring, radio frequency, cell, GPS, Bluetooth, infrared, Near Field Communication, etc.

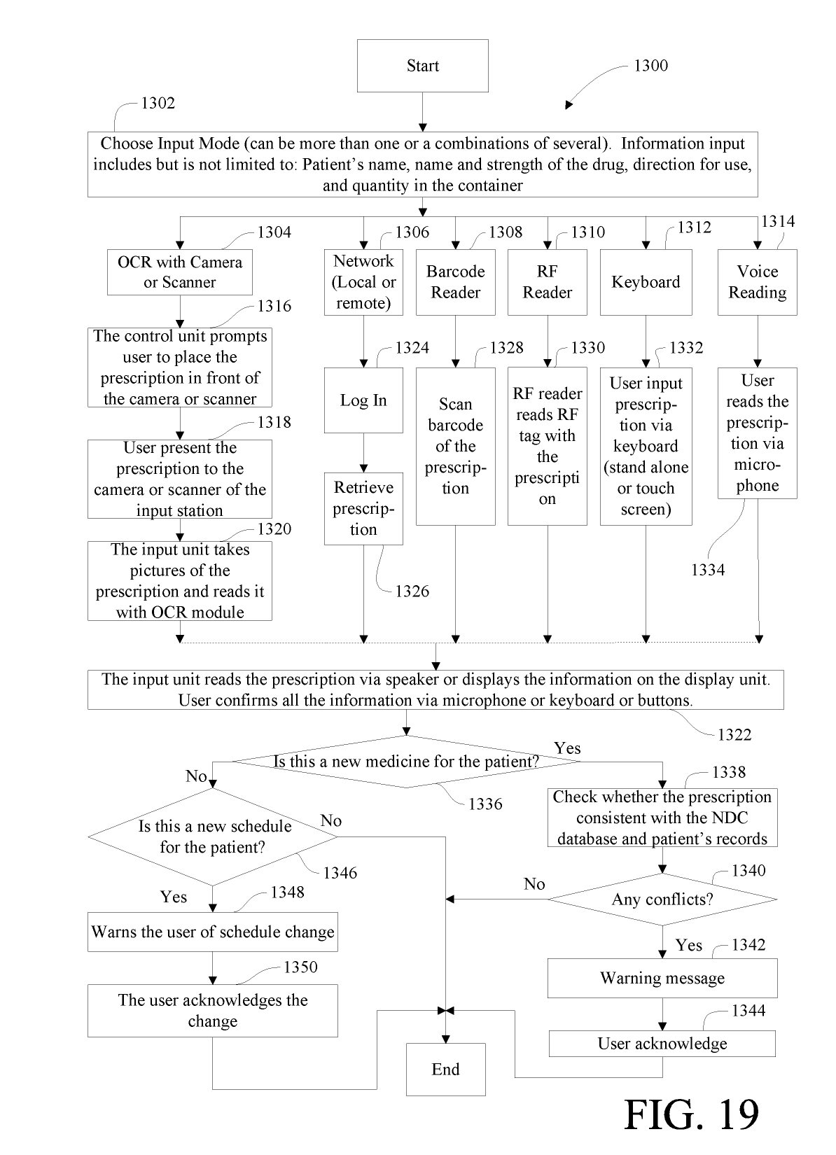

FIG. 19 is a flow diagram illustrating the possible methods for inputting prescription regimen data into the control device 102. Process 1300 may include operations that may be part of program 110, stored on memory 108, and/or executed by processor 106. Process 1300 may take many different forms and include multiple and/or alternate steps. While an exemplary process is shown, the exemplary steps illustrated are not intended to be limiting. Indeed, additional or alternative steps and/or implementations may be used.

At block 1302, processor 106 may initiate a choose input mode for one or a combination of inputs, including patient's name, name of medicine, strength or dosage of medication, directions for use, and quantity of medicine in the medicine container 320.

At block 1304, processor 106 may be in communication with and initiate OCR with I/O device 114 including a camera or scanner.

At block 1306, transceiver 116 may be in communication with network 118 (e.g., locally or remotely).

At block 1308, processor 106 may be in communication with I/O device 114 including a barcode reader.

At block 1310, processor 106 may be in communication with I/O device 114 including a radiofrequency (RF) reader.

At block 1312, processor 106 may be in communication with I/O device 114 including a keyboard.

At block 1314, processor 106 may be in communication with I/O device 114 including a recorder (e.g., voice, audio, and/or video).

At block 1316, control device 102 may initiate a user prompt to place the prescription in front of the camera or scanner.

At block 1318, the prescription may be presented to I/O device 114 including a camera or scanner.

At block 1320, the I/O device 114 may take pictures of the prescription and read it with an OCR module.

At block 1322, the I/O device 114 may read the prescription by way of a speaker or display the information on the display device 112. Further, the user may confirm the information by way of a microphone, keyboard, or buttons.

At block 1324, processor 106 may log into network 118.

At block 1326, transceiver 116 may receive medication information (e.g., the prescription) from memory 108 or database 122.

At block 1328, the I/O device 114 may scan the medicine identification (e.g., barcode) of the prescription.

At block 1330, the I/O device 114 (e.g., radiofrequency (RF) reader) may read a radiofrequency (RF) tag with the prescription.

At block 1332, the I/O device 114 may receive user inputs include the prescription by way of a keyboard (e.g., stand alone or touch screen).

At block 1334, the prescription may be received by the I/O device 114 (e.g., a microphone)

At block 1336, the processor 106 may determine if this is a new medicine for a patient. If yes, the processor 106 may check whether the prescription is consistent with the NDC database and the patient's records. If no, the processor 106 may determine if this is a new schedule for the patient.

At block 1338, the processor 106 may check whether the prescription is consistent with the NDC database or other databases and the patient's records

At block 1340, the processor 106 may determine if there are any conflicts.

At block 1342, the I/O device 114 may generate an indicator (e.g., warning message).

At block 1344, the I/O device 114 may receive a user acknowledgement.

At block 1346, the processor 106 may determine if this is a new schedule for the patient.

At block 1348, the I/O device 114 may generate an indicator (e.g., warning message indicating the schedule change).

At block 1350, the I/O device 114 may receive a user acknowledgement of the schedule change. After block 1350, the process ends.

Process 1300 may include alternative or additional embodiments. For example, the system may first prompt the user to input his or her prescription. The preferred way to input prescription information is through OCR. The user presents the prescription to the camera or scanner of the system and the system takes pictures or videos of the prescription. The OCR module of the system then transcribes the picture of the physical prescription on the bottle and stores it as text information.

Alternatively, some patients have accounts with some pharmacies or health care facilities where their prescriptions are stored online. In these cases, another way to input prescription information is to remotely login to a user's online account to retrieve his or her prescription from the existing database and transfer this information to our system.

Another embodiment of the prescription input method could be a standard keyboard (either physical or digital, like a touch screen keyboard). The user can use this keyboard to type in his or her prescription. Another embodiment of the prescription input method could be to use a microphone—the user would then be able to speak his prescription into the device to input his prescription information.

The system is also able to read in prescription information directly from RFID tags. This may include both RF communication and NFC and barcodes (1D or 2D) if the pharmacies or other health care facilities provide prescription information through these communication forms.

After the system receives prescription, the system may check the prescription information against National Drug Code database (NDC) or other databases, patient's medical records to prevent errors. Then the system may display or read out the prescription and ask the user to confirm that all information about to be programmed into the reminder device 155 is correct.

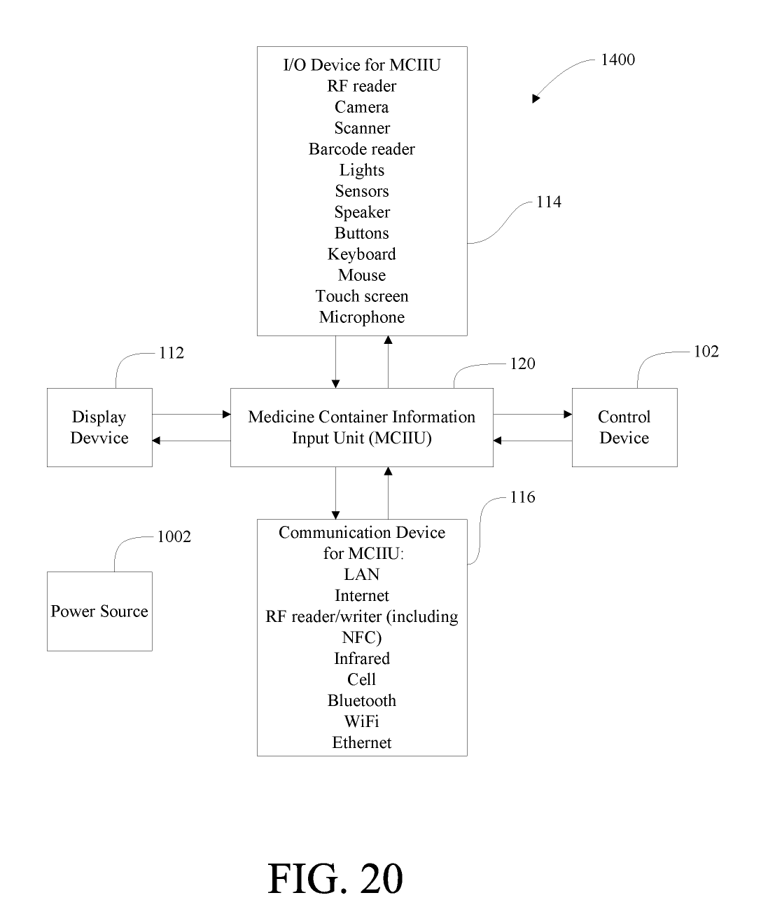

FIG. 20 is a schematic diagram including system 1400 including, for example, the hardware structure of the medication input device 120. The medication input device 120 may have a separate processor 106 or may utilize processor 106 of control device 102. The medication input device 120 may have I/O device 114 including, for example, radiofrequency (RF) reader, camera, scanner, barcode reader, one or more lights, one or more sensors, speaker, one or more buttons, keyboard, mouse, touch screen, microphone, or a combination thereof. System 1400 may include transceiver 116 (e.g., a communication module), such as LAN, WAN, RF reader, infrared, cell, Bluetooth, or WiFi-based communication technologies. The medication input device 120 may include display device 112 and power source 1002 or may share the display device 112 and power source 1002 of the control device 102.

The RF tag or the label may have an illuminating indicator. The reminder device 155 may activate the indicator of the container where medicine should be taken from or when needed. The reminder device 155 monitors the container and checks whether the right container is actually inside the reminder device 155 throughout operation.

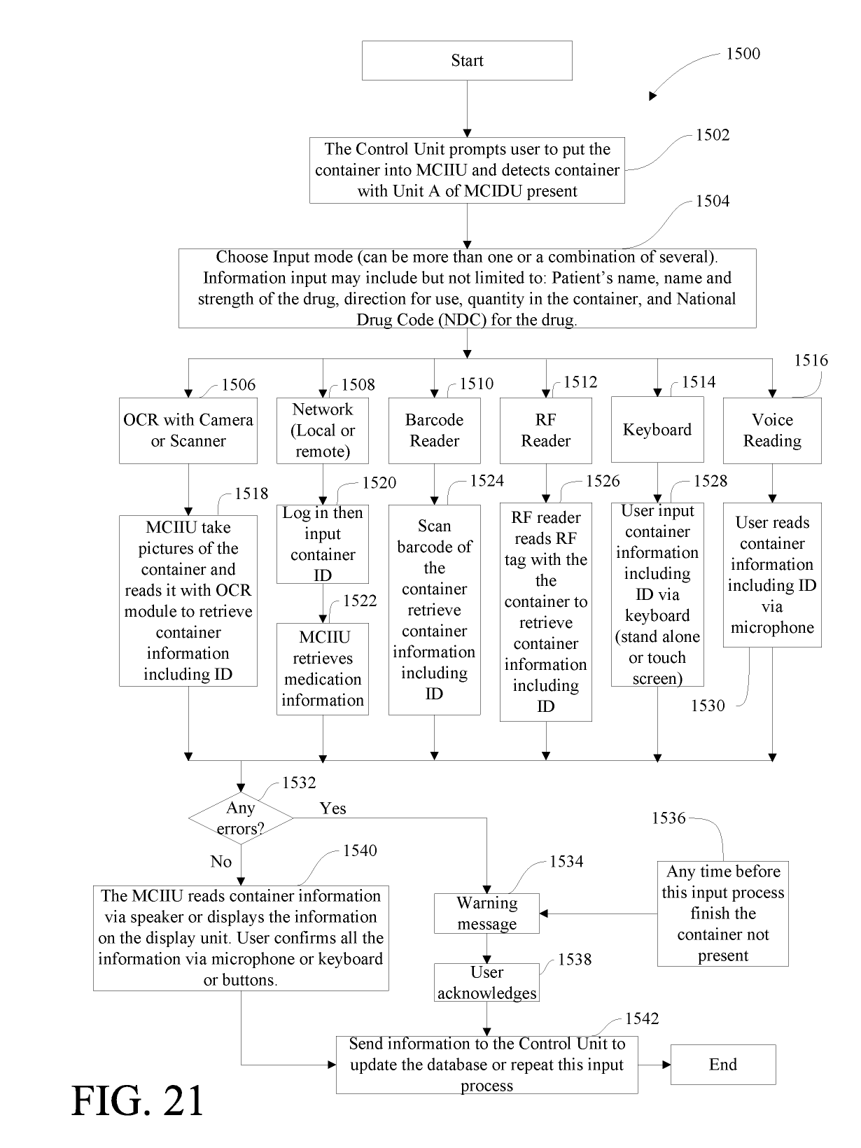

FIG. 21 is a flow diagram including exemplary process 1500, e.g., including operations of medication input device 120 (e.g., MCIIU). Process 1500 may include operations that may be part of program 110, stored on memory 108 or database 122, and/or executed by processor 106. Process 1500 may take many different forms and include multiple and/or alternate steps. While an exemplary process is shown, the exemplary steps illustrated are not intended to be limiting. Indeed, additional or alternative steps and/or implementations may be used.

At block 1502, the control device 102 may generate a user prompt (e.g., to put the medicine container assembly 130 into the medication input device 120 and detect the medicine container assembly 130

At block 1504, processor 106 may initiate a choose input mode for one or a combination of inputs, including patient's name, name of medicine, strength or dosage of medication, directions for use, quantity of medicine in the medicine container 320, and the National Drug Code (NDC) for the medication.

At block 1506, processor 106 may be in communication with and initiate OCR with I/O device 114 including a camera or scanner.

At block 1508, transceiver 116 may be in communication with network 118 (e.g., locally or remotely).

At block 1510, processor 106 may be in communication with I/O device 114 including a barcode reader.

At block 1512, processor 106 may be in communication with I/O device 114 including a radiofrequency (RF) reader.

At block 1514, processor 106 may be in communication with I/O device 114 including a keyboard.

At block 1516, processor 106 may be in communication with I/O device 114 including a recorder (e.g., voice, audio, and/or video).

At block 1518, medicine input device 120 may take pictures or videos of the medicine container assembly 130 and read it with the OCR module to retrieve container information (e.g., a container identifier).

At block 1520, may login the network and input container ID.

At block 1522, medication input device 120 may retrieve container information from the network.

At block 1524, the I/O device 114 may scan the medicine identification (e.g., barcode) of the medicine container.

At block 1526, the I/O device 114 (e.g., radiofrequency (RF) reader) may read a radiofrequency (RF) tag with the medicine container.

At block 1528, a user may input medicine container information by way of a keyboard (e.g., stand alone or touch screen).

At block 1530, a user may read container information by the I/O device 114 (e.g., a microphone)

At block 1532, the processor 106 may determine if there are any errors.

At block 1534, the I/O device 114 may generate an indicator (e.g., warning message).

At block 1536, the processor 106 may determine whether the medicine container assembly 130 was removed from the input device 120 regardless it was put back or not.

At block 1538, the I/O device 114 may receive a user acknowledgement of the schedule change. After block 1350, the process ends.

At block 1540, the medication input device 120 may read container information via the I/O device 114 (e.g., speaker) or displays the container information on the display 112. The user may confirm the information by way of the I/O device 114 (e.g., microphone, keyboard, or buttons).

At block 1542, the transceiver 116 may send information to the control device 102, e.g., to update the database 122 or repeat the process 1500. After block 1542, the process ends.

Process 1500 may include alternative or additional embodiments. The system may request that the user inputs drug information based on the drug container as well as the prescription; using multiple inputs, the system can check for errors during the input phase. The information may include the name and strength of the drug, special instructions for how to take the drug, the quantity of the drug inside the container, the NDC code of the drug if available on the container, or a combination thereof.

The user first has to attach the cap 530 of the device 155 to a medicine container 320 and then must place the entire assembly 130 on the medication input device 120. The medication input device 120 monitors the presence of the assembly 130 throughout the information input process. If the assembly 130 leaves the medication input device 120 for any reason at any time before the whole input process finishes, the medication input device 120 gives a warning signal and the whole process must restart from the beginning. For example, a way to input container information is through camera and OCR programming. The medication input device 120 may take pictures or videos of the medicine container assembly 130 and use an OCR module to read a container label.

Alternatively or in addition, some patients have accounts with some pharmacies or healthcare facilities where their prescriptions container information are stored online. In these cases, another way to input container information is to remotely login to a user's online account to retrieve the container information based on prescription number and/or container ID from the existing database and transfer this information to our system.

Another embodiment of the container information input method could be a standard keyboard (either physical or digital, like a phone keyboard). The user can use this keyboard to type in container information. Another embodiment of the container information input method could be to use a microphone—the user would then be able to read container information into the device.

The system is also able to read in container information directly from RFID tags, and barcodes (1D or 2D) if the pharmacies or other healthcare facilities provide those information through these communication forms on the container.

After the medication input device 120 reads in the container information, the control device 102 may compare the container information with the prescription information input before to check for any discrepancies.

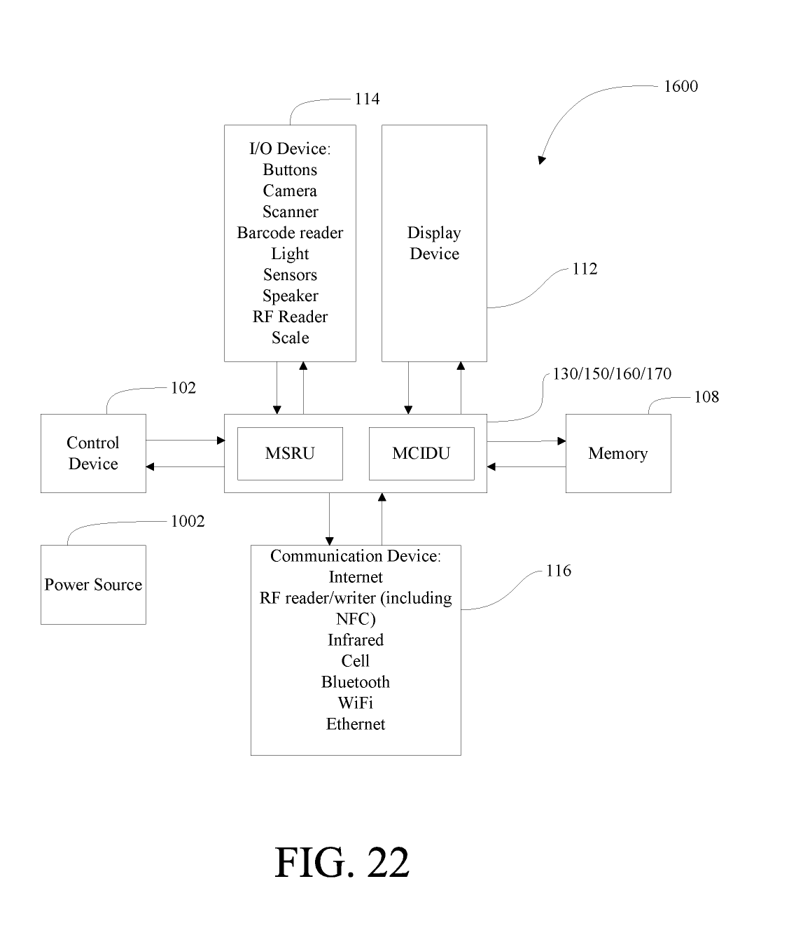

FIG. 22 is a schematic diagram of system 1600, e.g., for the device 155. The device 155 may include combined MSRU and/or MCIDU system, Control device 102, memory 108, display device 112, an I/O device 114, transceiver 116 (e.g., communication device), a scale or load cell or similar devices, and power source 1002. The I/O module 114 includes an RF reader, a camera, a scanner, a barcode reader, lights, sensors, a speaker, buttons, a load cell, and transceiver 116 having a communication module in the form of a LAN, WAN, RF reader, Infrared, cell, Bluetooth, or WiFi-based technology.

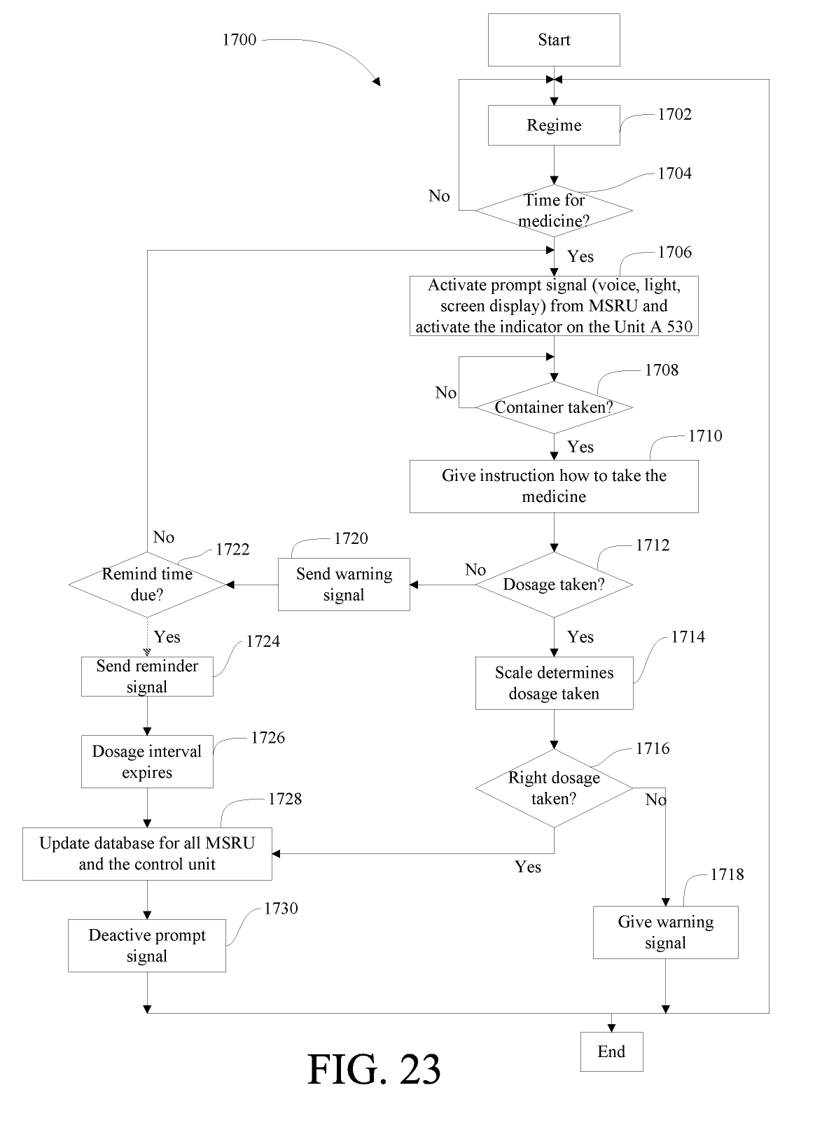

FIG. 23 illustrates a flow diagram including process 1700, e.g., of the operations of medication storage and reminder device 155 (e.g., MSRU). Process 1700 may include operations that may be part of program 110, stored on memory 108 or database 122, and/or executed by processor 106. Process 1700 may take many different forms and include multiple and/or alternate steps. While an exemplary process is shown, the exemplary steps illustrated are not intended to be limiting. Indeed, additional or alternative steps and/or implementations may be used.

At block 1702, processor 106 receives and initiates a regime (e.g., dosage, time to take, how to take, etc.) of memory 108 or database 122.

At block 1704, processor 106 determines whether it is time for the user to take medicine. If no, the processor 106 may wait until it is time to take the medicine. If yes, processor 106 may activate a prompt signal from the reminder device 155 and activates an indicator on the cap 530.

At block 1706, processor 106 may activate a prompt signal from the reminder device 155 and activates an indicator on the cap 530.

At block 1708, processor 106 may determine if the container device has been taken. If no, the processor 106 waits until the container is taken. If yes, processor 106 may provide instructions, by way of the display 112 and/or I/O device 114, on how to take medicine.

At block 1710, processor 106 may provide instructions, by way of the display 112 and/or I/O device 114, on how to take medicine/

At block 1712, processor 106 may determine whether dosage is taken. If no, the processor may initiate a warning signal. If yes, processor 106, by way of a scale, determines if the right dosage has been taken.

At block 1714, processor 106, by way of a scale, determines if the dosage has been taken.

At block 1716, processor 106 determines if the correct dosage was taken. If no, processor 106 generates an indicator (e.g., warning signal). If yes, processor 106 updates database 122 for one or all of the reminder devices 155 and the control device 102.

At block 1718, processor 106 generates an indicator (e.g., warning signal).

At block 1720, processor 106, by way of display 112 and/or I/O device 114, may generate an indicator (e.g., a warning signal).

At block 1722, processor 106 may determine whether a time reminder is due. If yes, processor 106 may generate an indicator (e.g., reminder signal). If no, the processor 106 may repeat block 1706.

At block 1724, processor 106 may generate an indicator (e.g., reminder signal).

At block 1726, processor 106 may determine when a dosage interval expires.

At block 1728, processor 106 may update memory 108 and/or database 122 for one or all of the reminder devices 155 and the control device 102.

At block 1730, processor 106 may deactivate the indicator (e.g., prompt signal). After block 1730, the process ends.

Process 1700 may include alternative or additional steps. For example, when it is time for the patient to take medicine, the reminder device 155 may activate a signal, such as a voice announcement with flash lights and a display on screen. The reminder device 155 may also activate the indicator on the container where the medicine should be taken from. When the container is opened, the reminder device 155 may give instructions about how much medication to take and how to take the medicine. For examples, these instructions could be “take 1 pill with a cup of water” or “take 2 pills with food”.

The reminder device 155 monitors whether the container is picked up or not or opened up or not. The prompt signal may be on until the container is opened or dosage interval time expired. Then the scale may monitor whether the right dosage is taken. If the wrong dosage is taken, the reminder device 155 may activate a local alarm (i.e. a visual or auditory cue on the reminder device 155) and remotely notify the patient's care team through some sort of message (e.g. an SMS message, a call, a phone app notification). If the right dosage is taken, reminder device 155 may record the dosage event—when the medication was taken, and how much—and send the information to the control device to update all information.

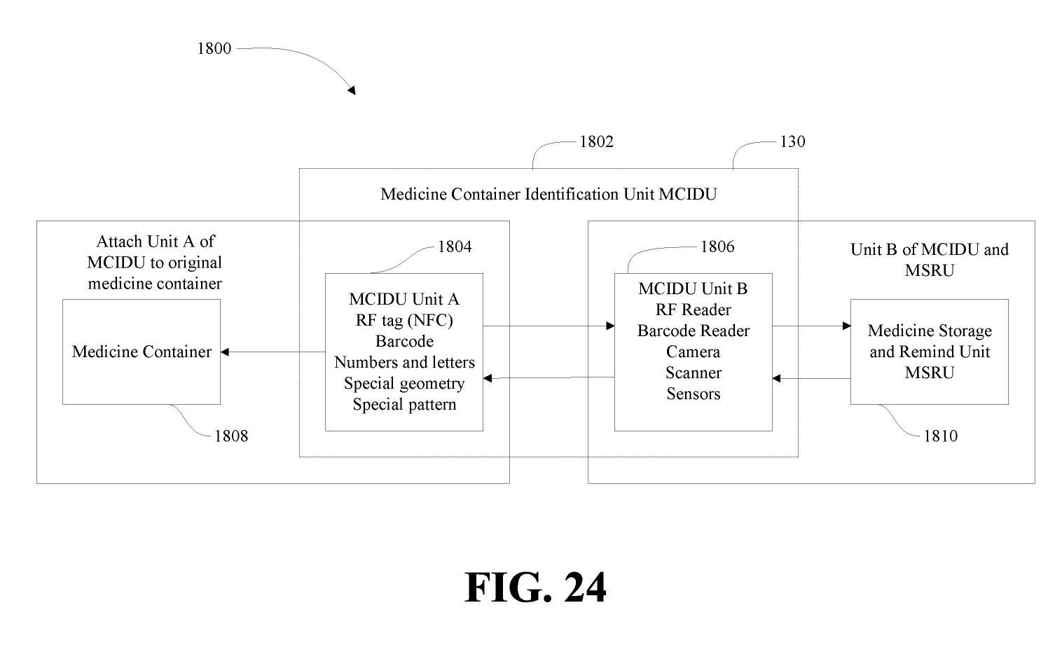

FIG. 24 is a schematic diagram of system 1800 including, for example, device 155. System 1800 may include device 1802 having identification device 1804 and identification device 1806. Identification device 1804 may be in communication with identification device 1808 For example, embodiments may include cap 530 having a peel off tag, a radiofrequency (RF) tag, a barcode label, a unique alphanumeric number (e.g., set of numbers and letters), or a combination thereof. Embodiment may also include an RF reader 515, a barcode reader, a camera, a scanner, one or more sensors, or a combination thereof. The RFID reader 515 may be integrated into and share hardware with the reminder device 155.

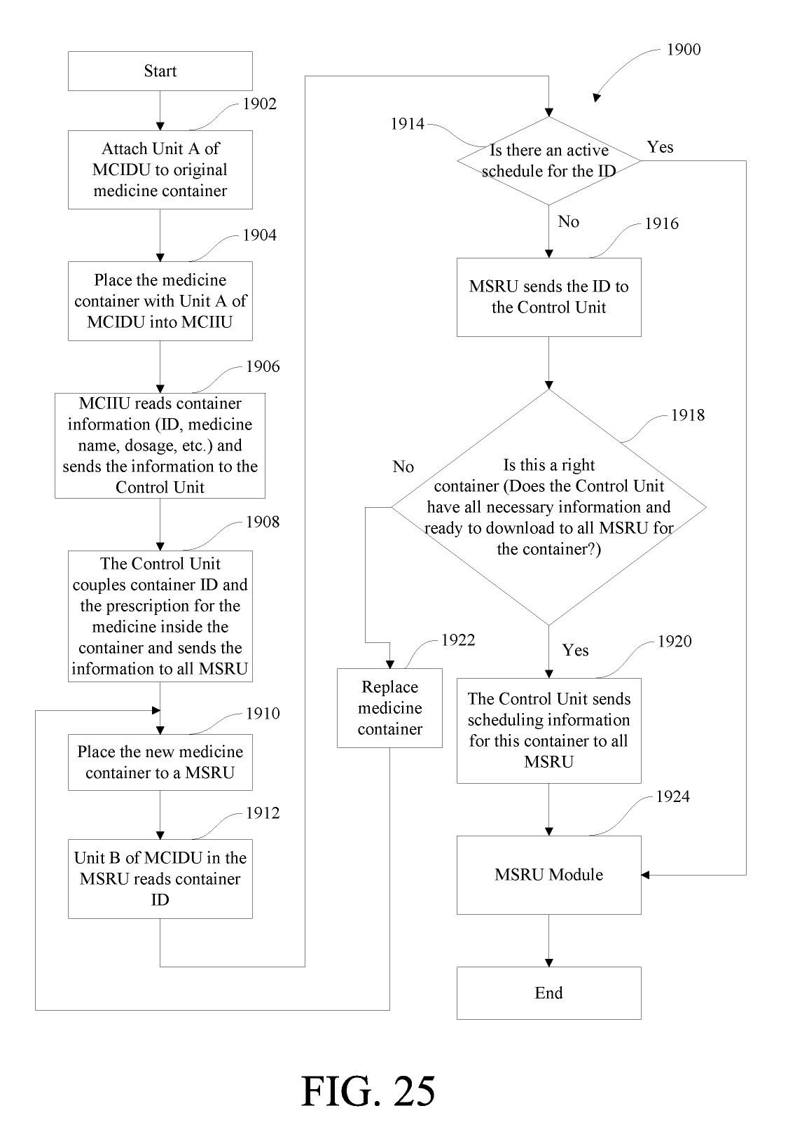

FIG. 25 is a flow diagram of an exemplary process 1900 including, for example, operations how the medicine container information input device 120 and the medication storage and reminder device 155 work together with control device 102 to link a prescription, medicine container 320, medicine container identifier 530, and medicine storage and reminder devices 155 together. Process 1900 may include operations that may be part of program 110, stored on memory 108 or database 122, and/or executed by processor 106. Process 1900 may take many different forms and include multiple and/or alternate steps. While an exemplary process is shown, the exemplary steps illustrated are not intended to be limiting. Indeed, additional or alternative steps and/or implementations may be used.

At block 1902, cap 530 may be attached to a medicine container 320 to form medication container assembly 130

At block 1904, medicine container assembly 130 may be placed into medication input device 120.

At block 1906, medication input device 120 may read container information (e.g., a container identifier associated with a patient name, a medicine name, a dosage, etc.) and send the container information to the control device 102.

At block 1908, the control device 102 may associate container information and medicine information (e.g., a medicine identifier associated with prescription information for the medicine inside the container) and send the information to one or a plurality of reminder devices 155.

At block 1910, a new medicine container assembly 130 may be placed onto the reminder device 155, e.g., into the recess of the reminder device 155.

At block 1912, the reminder device 155, by way of the RFID reader, may read the container information.

At block 1914, the processor 106 may determine if there is scheduling information (e.g., an active schedule) for the container. If yes, then the reminder device 155 generates an alert. If no, the reminder device 155 sends the identifier information to the control device 102.

At block 1916, the transceiver, e.g., of reminder device 155, sends the identifier to the control device 102.

At block 1918, the processor 106 compares the container information and the medicine information to determine if whether the medicine container is the correct one. This may include determining whether the control device 102 has the necessary information and is ready to download to one or all of the reminder devices 155 for the medicine container 320. If the container information and medicine information do not match, the process 1900 restarts at block 19010. If the container information and medicine information do match, the control device 102 sends scheduling information for the medicine container 320 to one or all of the reminder devices 155.

At block 1920, the transceiver 116, e.g., of control device 102, sends the scheduling information of the medicine container 320 to all of the reminder devices 155.

At block 1922, the display 112 or I/O device 114 indicates that the medicine container 320 should be replaced and replace the medicine container then restarts at block 1910

At block 1924, the reminder device 155 initiates medication storage and reminder module. After block 1924, the process ends.

Process 1900 may include alternative or additional embodiment. For example, users may attach the cap 530 to a medicine container 320 to form assembly 130. Then the user may place the assembly 130 into the medication input device 120 to input the container information. Then the medication input device 120 sends the container information to the control device 102. The control device 102 may direct the user to place the medicine container assembly 130 in an available reminder device 155. After the reminder device 155 sends the container ID to the control device 102, the control device 102 may send medication information to the reminder device 155. Then the reminder device 155 may start the regime module.

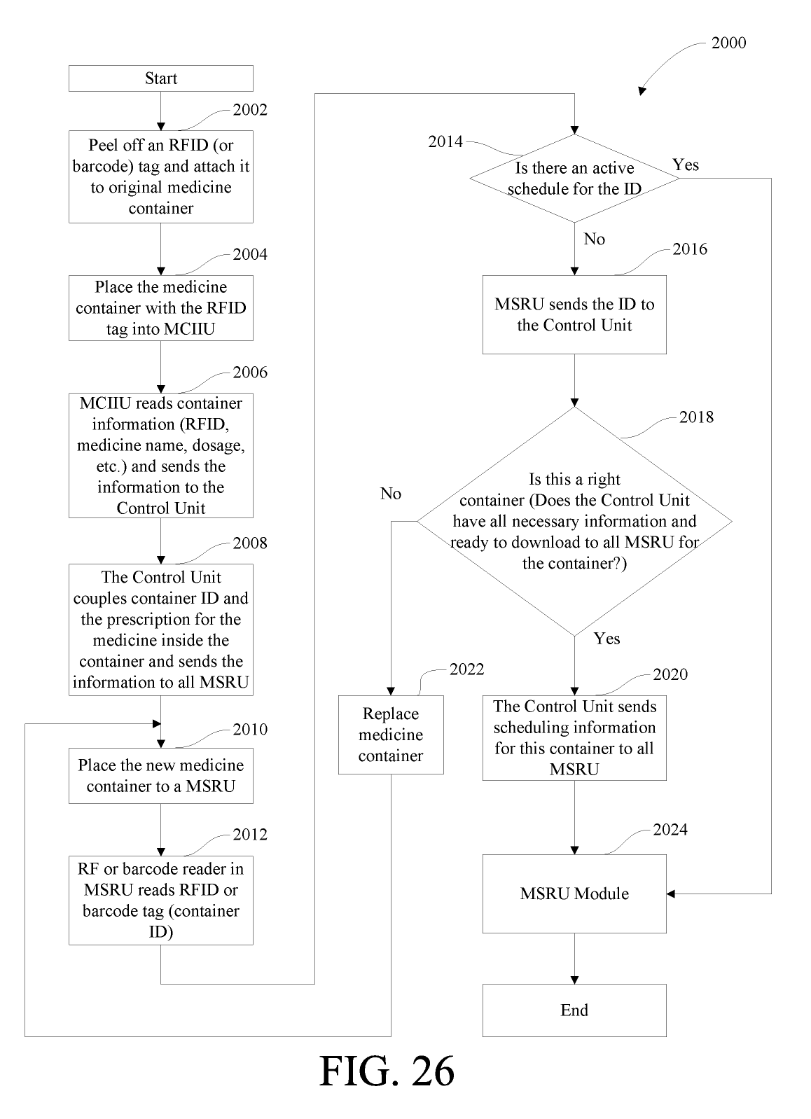

FIG. 26 is a flow diagram including process 2000 including, for example, a method for use of passive RFID tags or barcodes (e.g., 1D or 2D) as medicine container identifier (e.g. Cap 530) illustrates how the medicine container information input device 120 and the medication storage and reminder device 155 work together with control device 102 to link a prescription, medicine container 320, medicine container identifier 530, and medicine storage and reminder devices 155 together. Process 2000 may include operations that may be part of program 110, stored on memory 108 or database 122, and/or executed by processor 106. Process 2000 may take many different forms and include multiple and/or alternate steps. While an exemplary process is shown, the exemplary steps illustrated are not intended to be limiting. Indeed, additional or alternative steps and/or implementations may be used.

At block 2002, tag 445 (e.g., a radiofrequency identification tag) may be peeled of and attached to an original medicine container 320.

At block 2004, medicine container 320, while attached to tag 445, may be placed onto medication input device 120.

At block 2006, medication input device 120 may read container information (e.g., a radiofrequency container identifier) and send the container information to the control device 102.

At block 2008, the control device 102 may associate container information and medicine information (e.g., a medicine identifier associated with prescription information for the medicine inside the container) and send the information to one or a plurality of reminder devices 155.

At block 2010, the medicine container 320 may be placed on the reminder device 155, e.g., into the recess of the reminder device 155.

At block 2012, assembly 130 as part of the reminder device 155, e.g., by way of a radiofrequency or barcode reading device, may read the tag 445 (e.g., an identifier associated with container information such as an RFID or barcode tag).

At block 2014, the processor 106 may determine if there is scheduling information (e.g., an active schedule). If yes, then the reminder device 155 initiates the Medication Storage and Reminder module. If no, the reminder device sends the identifier to the control device 102.

At block 2016, the transceiver, e.g., of reminder device 155, sends the identifier to the control device 102.

At block 2018, the processor 106 compares the container information and the medicine information to determine if whether the medicine container is the correct one. This may include determining whether the control device 102 has the necessary information and is ready to download to one or all of the reminder devices 155 for the medicine container 320. If the container information and medicine information do not match, choose a different medicine container and the process 2000 restarts at block 2010. If the container information and medicine information do match, the control device 102 sends scheduling information for the medicine container 320 to one or all of the reminder devices 155.

At block 2020, the transceiver 116, e.g., of control device 102, sends the scheduling information of the medicine container 320 to all of the reminder devices 155.

At block 2022, the display 112 or I/O device 114 indicates that the medicine container 320 should be replaced. A user replaces the medicine container and restarts at block 2010.

At block 2024, the reminder device 155 initiates Medication Storage and Reminder module. After block 2024, the process ends.

Process 2000 may include alternative or additional embodiments. Users may first attach the RF tag or barcode label to the medicine container 320. Then the user may input container information through the medication input device 120 and place the container into an available reminder device 155. After the reminder device 155 reads the ID information and retrieves medicine information from the control device 102, the reminder device 155 logic starts.

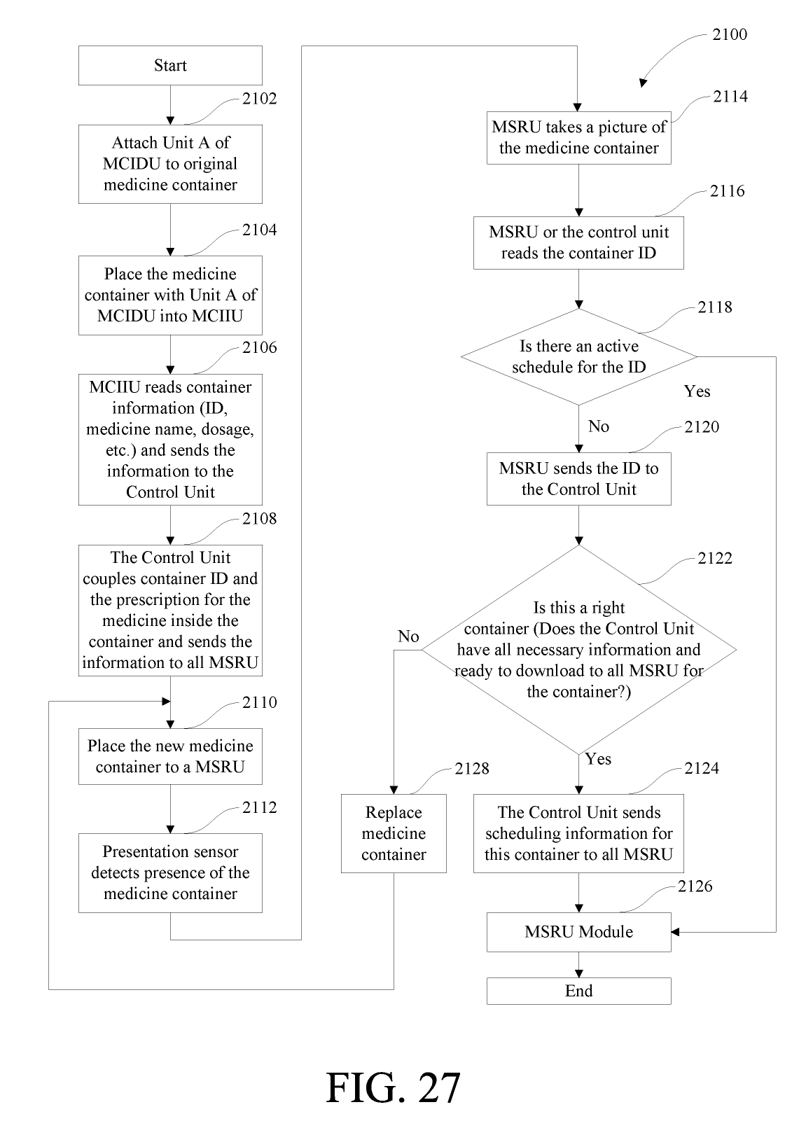

FIG. 27 is a flow diagram illustrating another method to determine how to link a prescription, medicine container, medicine container identifier, and the MSRU together, using pictures and OCR in this embodiment of the disclosure. Process 2100 may be part of program 110, stored on memory 108, and/or executed by processor 106 to provide the operations of blocks 2002-2126. Process 2100 may take many different forms and include multiple and/or alternate steps. While an exemplary process is shown, the exemplary steps illustrated are not intended to be limiting. Indeed, additional or alternative steps and/or implementations may be used.

Process 2100 my include alternative or additional embodiments. For example, after the user attaches the cap 530 to a container 320 and places the assembly 130 into the medication input device 120, the medication input device 120 may take pictures and read all the information through OCR and send this information to the control device 102. After the user places the assembly 130 into the reminder device 155, another set of pictures may be taken and sent to the control device 102. Information retrieved from these two sets of pictures via OCR has to match; otherwise the system may stop working and give alarm signals. The reminder device 155 always monitors the container inside the reminder device 155. Every time the container leaves the reminder device 155, a new set of pictures have to be taken.

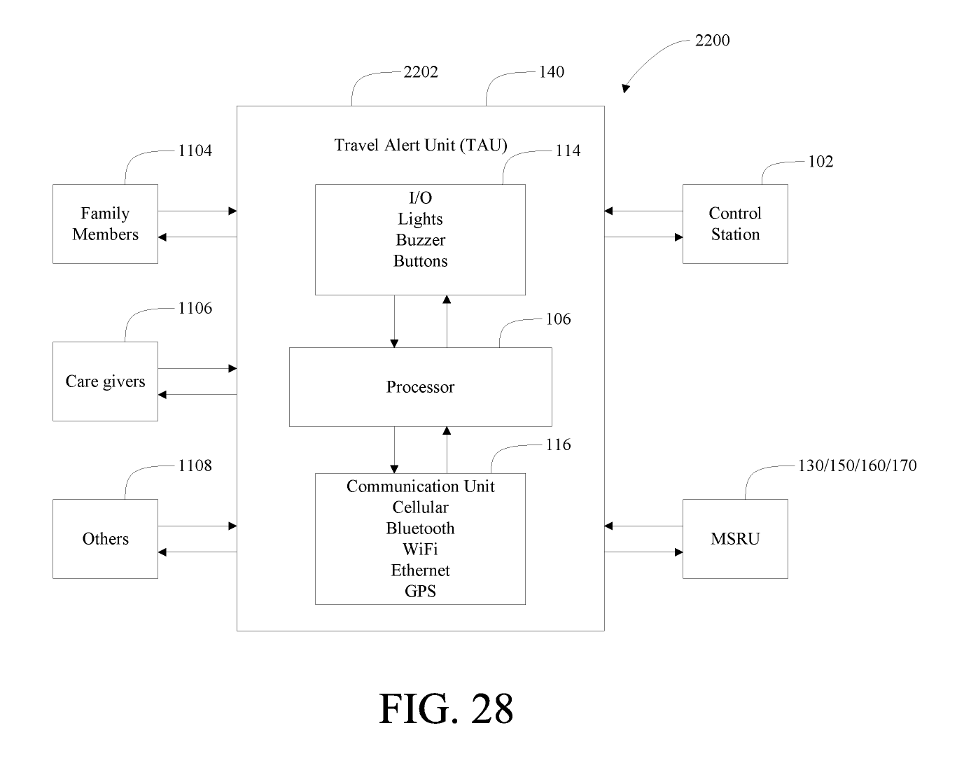

FIG. 28 illustrates a schematic diagram including system 2200. System 2200 may include assembly 2202, e.g., including alert device 140. Assembly 2202 may be in communication with control device 102, devices 150-170, family member devices 1104, care giver devices 1106, other devices 1108, e.g., a doctor. Alert device 140 may have a processor 106, an I/O device 114 (e.g., a light, a buzzer, a button, one or more sensors, or a combination thereof), and transceiver 116 (e.g., a communication module in the form of a LAN, WAN, Infrared, cell, Bluetooth, or WiFi-based technology).

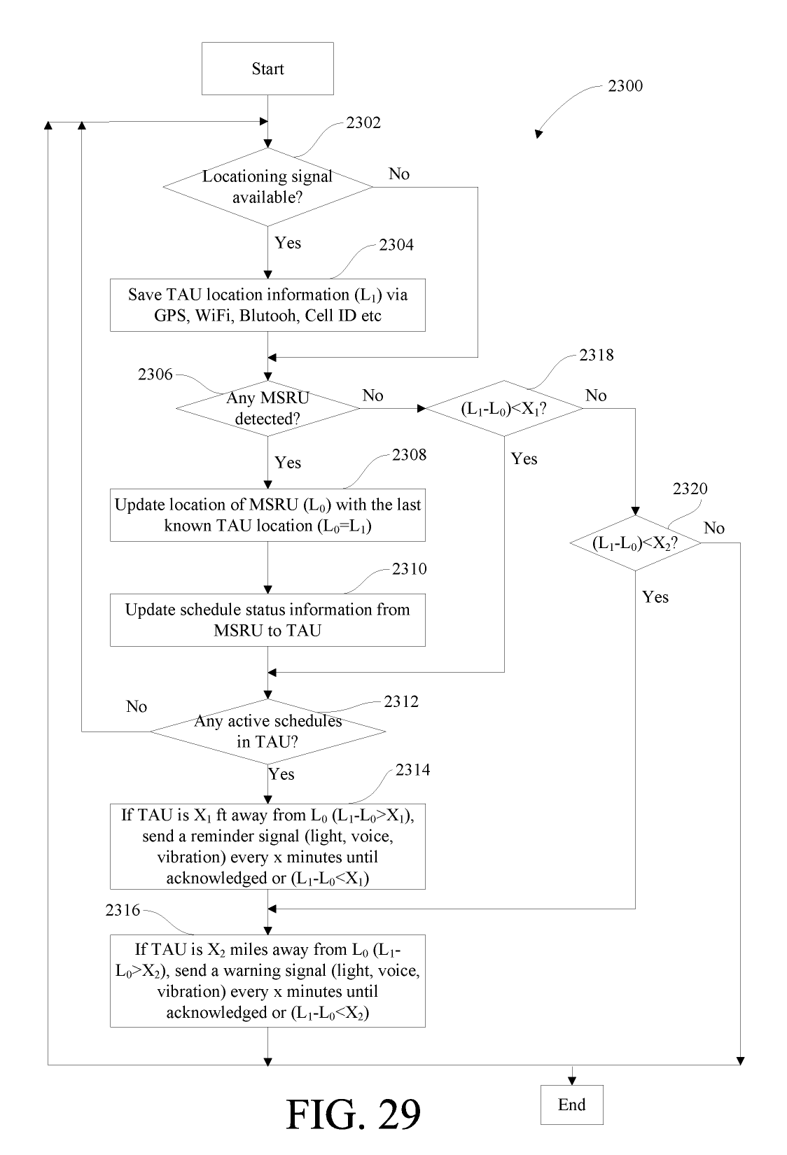

FIG. 29 illustrates a flowchart including exemplary process 2300 including, for example, operations of the alert device 140. Process 2300 may include operations that are part of program 110, stored on memory 108, and/or executed by processor 106. Process 2300 may take many different forms and include multiple and/or alternate steps. While an exemplary process is shown, the exemplary steps illustrated are not intended to be limiting. Indeed, additional or alternative steps and/or implementations may be used.

At block 2302, processor 106, by way of transceiver 116, may determine if location information is available. If available, the process may proceed to block 2304. If not available, the process may proceed to block 2306.

At block 2304, the processor 106, by way of GPS, WiFi, Bluetooth, or cellular identification or triangulation, may determine the location information and save the location information to memory 108 or database 122.

At block 2306, the processor 106, may determine whether one or more devices 150 to 170 are within its communication range. If present, the process may proceed to block 2308. If not present, the process may proceed to block 2318.

At block 2308, the processor 106 may update the location information of the assembly 150 with location information of the alert device 140.

At block 2310, the processor 106 may update schedule status information (e.g., any active medicine regime for any devices 150 to 170), from the assemblies 150 to 170 to the alert device 140.

At block 2312, the processor 106 may determine if there are any active schedules (e.g., dosage and when to take a medicine) in the alert device 140. If yes, the process may proceed to block 2314. If no, the process may restart at block 2302.

At block 2314, the processor 106 may generate, by way of display 112 and/or I/O device 114, an indication (e.g., reminder signal such as light, voice, vibration, or a combination thereof) in response to the alert device 140 being outside a short-range predefined distance but within a longer predefined distance (e.g., a number of feet or a smaller geographical area) away from the assembly 150. The indication may be in predefined time increments until acknowledged or until the distance between the alert device 140 and the assembly 150 is less than the short-range predefined distance or a first predefined threshold.

At block 2316, the processor 106 may generate, by way of display device 112 and/or I/O device 114, an indication (e.g., reminder signal such as light, voice, vibration, or a combination thereof) in response to the alert device 140 being outside a long-range predefined distance (e.g., a number of miles or a larger geographical area) away from the assembly 150. The indication may be in predefined time increments until acknowledged or until the distance between the alert device 140 and the assembly 150 is less than the long-range predefined distance or a second predefined threshold.

At block 2318, the processor 106 may determine whether the distance between the alert device 140 and assembly 150 is less than the short-range predefined distance or the first predefined threshold.

At block 2320, the processor 106 may determine whether the distance between the alert device 140 and assembly 150 is less than the long-range predefined distance or the second predefined threshold. After block 2320, the process ends.

Process 2300 may include alternative or additional embodiments. For example, alert device 140 constantly detects and saves its location via GPS, cell towers (e.g., cellular triangulation), WiFi stations, or other location determination technologies. Alert device 140 also constantly communicates with assemblies 155 (e.g., MSRU). It also detects, updates, and saves the location of assemblies 155. Alert device 140 saves all active schedule status for all MSRUs. Then alert device 140 calculates the distance L between itself and the MSRUs. If the distance L is larger than a predefined distance X₁ (e.g. 1000 ft.) and there is any active drug schedule, then alert device 140 may give an alert signal via light, buzzer, or vibration, or may send an alert signal to a third party via cell phone, internet, and so on to remind the TAU is leaving the assembly 150 behind. If the L is larger than a second predefined distance X₂ (e.g. 20 miles), it may again give a warning signal via lights, buzzer, or vibration, and/or send a warning signal to a third party via cell phone, internet, and so on. All messages may be reset if the user acknowledges or the distance is less than X₁ or X₂.

An exemplary reminder system and methods may be configured for medicine regimen compliance. Embodiments may include a medicine container with medicine obtained from any pharmacy, hospital, or other dispensing facility, a medicine identifier attached to a container by a user, and a monitoring device associated with a monitor identifier. The monitoring device may include a microprocessor, memory and an output device. The monitoring device may provide operations including compare, by the microprocessor, the medicine identifier of the medicine container and the monitor identifier of the monitoring device. The operations may further include generate, by the output device, an alert in response to the comparison between the medicine identifier and the monitor identifier.

Another reminder system and methods may be configured for medicine regimen compliance monitoring. Embodiments may include a monitoring device having a recess adapted to receive a medicine container. The recess may be configured to releaseably couple the monitoring device and the medicine container. The monitoring device may have a controller including a microprocessor and memory. The microprocessor may provide operations including generate an alert in response to a medicine being removed from the medicine container.

An exemplary device 102 may include any computing device such as include a mobile device, cellular phone, smartphone, tablet computer, next generation portable device, handheld computer, notebook, or laptop. Device 102 may include processor 106 that executes program 110. Device 102 may include memory 108 that stores medication information and program 110. The device 102 may include transceiver 116 that communicates medication information between assemblies 102-170, server 104, network 118, and database 122.

Server 104 may include any computing system. For example, server 104 may include a user profile server for generating and storing a user profile for each user, server 104 may be configured to generate and store medication information The server 104 may be configured to communicatively connect with and transfer information between with respect to any of devices/assemblies 102, 120, 130, 140, 150, 160, and/or 170 (hereinafter “assemblies 102-170”), network 118, and database 122. Server 104 may be in continuous or periodic communication with assemblies 102-170, network 118, and/or database 122. Servers 104 may include a local, remote, or cloud-based server or a combination thereof and may be in communication with and provide medication information (e.g., as part of memory 108 or database 122) to any of assemblies 102-170, network 118, and/or database 122. The server 104 may further provide a web-based user interface (e.g., an internet portal) to be displayed by display 112. The server 104 may communicate the medication information with assemblies 102-170, network 118, and/or database 122 using a notification including, for example automated phone call, short message service (SMS) or text message, e-mail, http link, web-based portal, or any other type of electronic communication. In addition, the server 104 may be configured to store medication information as part of memory 108 or database 122. The server 104 may include a single or a plurality of centrally or geographically distributed servers 104. Server 104 may be configured to store and coordinate medication information with any portion of the systems herein.

The display 112 may include any display or mechanism to connect to a display, support user interfaces, and communicate medication information within the system 100. Any of the inputs into and outputs from display 112 may be included into medication information. The display 112 may include any input, output, or combination input/output device to facilitate the receipt or presentation of information (e.g., medication information) in audio, visual or tactile form or a combination thereof. Examples of a display may include, without limitation, a touchscreen, cathode ray tube display, light-emitting diode display, electroluminescent display, electronic paper, plasma display panel, liquid crystal display, high-performance addressing display, thin-film transistor display, organic light-emitting diode display, surface-conduction electron-emitter display, laser TV, carbon nanotubes, quantum dot display, interferometric modulator display, and the like. The display may present user interfaces to any user of the devices herein.

The assemblies 102-170 and network 118 may include or utilize location determination technology that enables the determination of location information (e.g., a current geographic position) of the user of assemblies 102-170. Examples of location determination technology may include or utilize, without limitation, global positioning systems (GPS), indoor positioning system, local positioning system, mobile phone tracking, and cellular triangulation. Assemblies 102-170 may determine location in conjunction with network 118. The assemblies 102-170 may be configured to provide a current geographic position of assemblies 102-170, for example, to provide a user location.

The connections 124 may be any wired or wireless connections between two or more endpoints (e.g., devices or systems), for example, to facilitate transfer of medication information. Connections 124 may include a local area network (LAN) connection, for example, to communicatively connect the assemblies 102-170, server 104, and database 122 with network 118. Connections 124 may include a wide area network (WAN) connection, for example, to communicatively connect server 104 with network 118. Connections 124 may include a radiofrequency (RF), near field communication (NFC), Bluetooth®, Wi-Fi, or a wired connection, for example, to communicatively connect assemblies 102-170.

The transceiver 116 (e.g., of assemblies 102-170) may communicatively connect the devices of system 100, for example, using any type of wired or wireless network connection. The transceiver 116 may include a single transceiver or a combination of transmitters and receivers. The wireless network may utilize a wireless transmitter (e.g., cellular, radiofrequency (RF) or Wi-Fi transmitter) of transceiver 116. Transceiver 116 may be configured to communicatively connect any or all of assemblies 102-170, server 104, and network 118. Transceiver 116 may be used for digital or analog signal transfers. For instance, transceiver 116 may include any antenna technology including cellular, V2V communication, radiofrequency (RF), near field communication (NFC), Bluetooth®, Wi-Fi, or the like. Transceiver 116 may include any technology that implements a wireless exchange of occupant information by converting propagating electromagnetic waves to and from conducted electrical signals. Transceiver 116 may include any technology that is used to exchange medication information wirelessly using radio waves over a radio range or network that enables communication.

Any portion of system 100, e.g., assemblies 102-170 and server 104, may include a computing system and/or device that includes a processor 106, memory 108 and connection 124. Computing systems and/or devices generally include computer-executable instructions, where the instructions may be executable by one or more devices such as those listed below. Computer-executable instructions may be compiled or interpreted from computer programs created using a variety of programming languages and/or technologies, including, without limitation, and either alone or in combination, Java™, C, C++, Visual Basic, Java Script, Perl, SQL, PL/SQL, Shell Scripts, etc. The system 100, e.g., assemblies 102-170 and server 104 may take many different forms and include multiple and/or alternate components and facilities, as illustrated in the Figures further described below. While exemplary systems, devices, modules, and sub-modules are shown in the Figures, the exemplary components illustrated in the Figures are not intended to be limiting. Indeed, additional or alternative components and/or implementations may be used, and thus the above communication operation examples should not be construed as limiting.

In general, computing systems and/or devices (e.g., assemblies 102-170 and server 104) may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing systems and/or devices such as device 102 and server 104 may include, without limitation, mobile devices, cellular phones, smart-phones, super-phones, tablet computers, next generation portable devices, mobile printers, handheld computers, notebooks, laptops, secure voice communication equipment, networking hardware, computer workstations, or any other computing system and/or device.

Further, processor 106 may include a microprocessor. Processor 106 may receive instructions from memories such as memory 108 or database 122 and execute the instructions, thereby performing one or more operations or processes including those described herein. Such instructions and other medication information may be stored and transmitted using a variety of computer-readable mediums (e.g., memory 108 or database 122). Processors such as processor 106 may include any computer hardware or combination of computer hardware that is configured to accomplish the purpose of the devices, systems, and processes described herein. For example, the processor 106 may be any one of, but not limited to single, dual, triple, or quad core microprocessors (on one single chip), graphics processing devices, visual processing devices, and virtual processors.

A memories such as memory 108 or database 122 may include, in general, any computer-readable medium (also referred to as a processor-readable medium) that may include any non-transitory (e.g., tangible) medium that participates in providing medication information or instructions that may be read by a computer (e.g., by the processors 106 of the assemblies 102-170 and server 104). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including radio waves, metal wire, fiber optics, and the like, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Further, databases, data repositories or other medication information stores (e.g., memory 108 and database 122) described herein may generally include various kinds of mechanisms for storing, providing, accessing, and retrieving various kinds of medication information, including a hierarchical database, a set of files in a file system, an application database in a proprietary format, a relational database management system (RDBMS), etc. Each such medication information store may generally be included within (e.g., memory 108) or external (e.g., database 122) to a computing system and/or device (e.g., assemblies 102-170 and server 104) employing a computer operating system such as one of those mentioned above, and/or accessed via a network (e.g., system 100 or network 118) or connection in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above. Memory 108 and database 122 may be connected to or part of any portion of system 100.

The description and specific examples herein are intended for purposes of illustration only and are not intended to limit the scope of present disclosure. None of the structures or steps herein are essential to any other structures or functions herein, and any may be omitted, added, or replaced with others. It will be appreciated by those skilled in the art that the present disclosure may be embodied in other specific forms without departing from the spirit or character thereof. The described embodiments are therefore considered in all respects to be illustrative not restrictive. The scope of the disclosure is indicated by the appended claims, not the foregoing description, and all changes that come within the meaning and range of equivalents thereof are intended to be embraced therein.

What is claimed is:

1. A reminder system for medicine regimen compliance and monitoring, the system including:
a control device, the control device having a microprocessor, memory, an input device and an output device, wherein the control device provides operations including:
receive prescription information, and
compare, by the microprocessor, prescription information and medicine container information, and
generate, by the output device, an alert in response to the comparison.

2. The system of claim 1, further comprising:
a medicine container;
a medicine identifier;
a medicine information input device, the device having a microprocessor, memory, an input device and an output device, wherein the medicine information input device provides operations including: receive medicine container information; and
a portable electronic device.

3. The system of claim 2, further comprising:
a monitoring device, the monitoring device having a microprocessor, memory, an input device and an output device, wherein the monitoring device provides operations including:
compare, by the microprocessor, the medicine identifier of the medicine container and the medicine information, and
generate, by the output device, an alert in response to the comparison.

4. The system of claim 1, the operations further comprising: determine an amount of medication removed from the medicine container.

5. The system of claim 1, the operations further comprising: compare the removed amount to a medicine regimen to determine compliance or non-compliance of the medicine container.

6. The system of claim 1, the operations further comprising: receive medicine information by way of machine reading of a prescription.

7. The system of claim 1, the operations further comprising: receive medicine information by way of machine reading of a label of a medicine container.

8. The system of claim 1, the operations further comprising: compare information for prescription and medicine container and transfer medication information to the monitoring device.

9. The system of claim 1, the operations further comprising: automatically monitor a distance between a portable electronic device and the medicine container, and generate an alert in response to the distance exceeding a threshold.

10. A reminder system for medicine regimen compliance and monitoring, the device including
a control device, the control device having a microprocessor, memory, an input device and an output device, wherein the control device provides operations including:
receive prescription information, and
compare, by the microprocessor, the prescription and medicine container information, and
generate, by the output device, an alert in response to the comparison;
a medicine container; and
a medicine identifier.

11. The system of claim 10, further comprising:
a medicine information input device having a microprocessor, memory, an input device and an output device, wherein the medicine information input device receives medicine container information;
a portable electronic device, and
a monitoring device having a microprocessor, memory, an input device and an output device, wherein the monitoring device provides operations including:
compare, by the microprocessor, the medicine identifier of the medicine container and the medicine information, and
generate, by the output device, an alert in response to the comparison.

12. The system of claim 10, the operations further comprising: determine an amount of medication removed from the medicine container, and compare the removed amount to a medicine regimen to determine compliance or non-compliance of the medicine container.

13. The system of claim 10, the operations further comprising: receiving medicine information by way of machine reading of a prescription.

14. The system of claim 10, the operations further comprising: receiving medicine information by way of machine reading of a label of a medicine container.

15. The system of claim 10, the operations further comprising: compare information for prescription and medicine container and transfer medication information to the monitoring device.

16. The system of claim 10, the operations further comprising: automatically monitor a distance between a portable electronic device and the medicine container, and generate an alert in response to the distance exceeding a threshold.

17. A method of a reminder system having medicine container and a monitoring device including a microprocessor, memory, input device and an output device, the method comprising:
applying a medicine identifier to the medicine container;
coupling the medicine container with the monitoring device via the medicine identifier;
comparing, by the microprocessor of the monitoring device, the medicine identifier of the medicine container and medicine information; and
generating an alert in response to the comparison of the medicine identifier and the monitor identifier.

18. The method of claim 17, further comprising: determining an amount of medication removed from the medicine container, and comparing the removed amount to a medicine regimen to determine compliance or non-compliance of the medicine container.

19. The method of claim 17, further comprising: receiving medicine information by way of machine reading of a prescription.

20. The method of claim 17, further comprising:
receiving medicine information by way of machine reading of a label of a medicine container;
comparing information for prescription and medicine and transferring medication information to the monitoring device;
automatically monitoring a distance between a portable electronic device and the medicine container, and
generating an alert in response to the distance exceeding a threshold.
